(19) United States
(12) Patent Application Publication
(10) Pub. No.: US 2026/0291957 A1
(43) Pub. Date: Sep. 24, 2026

(54) SYSTEM

(71) Applicant: SoftBank Group Corp., Tokyo (JP)

(72) Inventor: Takaya YAMAGUCHI, Tokyo (JP)

(73) Assignee: SoftBank Group Corp., Tokyo (JP)

(21) Appl. No.: 19/557,599

(22) Filed: Mar. 5, 2026

(30) Foreign Application Priority Data
Mar. 19, 2025 (JP) 2025-044934

(51) Int. Cl. H04L 9/40; G06F 40/205; G06F 40/284; G06F 40/40

(52) U.S. Cl. CPC H04L 63/1416; G06F 40/205; G06F 40/284; G06F 40/40

(57) ABSTRACT

A system includes a processor that is configured to: receive information as input and generate a prompt sentence for instructing a generative AI model to perform an information retrieval based on the input information: input the generated prompt sentence to the generative AI model and obtain legitimate identification information of a sender; and determine whether spoofing is present by comparing the obtained legitimate identification information with identification information received as the input.

### CROSS-REFERENCE TO RELATED APPLICATION

This application is based on and claims priority under 35 USC 119 from Japanese Patent Application No. 2025-044934 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional spoofing detection techniques for electronic communications, such as email filtering based on blacklists, heuristic rules, or static pattern matching, often fail to reliably distinguish between legitimate communications and sophisticated spoofed messages. In particular, when an attacker forges identification information such as a sender address or account identifier to mimic a legitimate entity, existing systems may lack access to up-to-date, context-aware information about which identification information is actually legitimate for that purported sender. As a result, spoofed messages can bypass conventional filters, causing users to be exposed to phishing, fraud, and other security threats.

Furthermore, traditional systems generally rely on preconfigured databases or manually maintained rules that do not dynamically reflect current public information accessible on the Internet. These approaches are not well suited to adapt to new domains, newly issued official contact points, or changes in the way organizations present their contact information. There is therefore a need for a mechanism that can automatically obtain legitimate identification information of a sender from externally available information, and compare such legitimate identification information with identification information included in an incoming communication to determine whether spoofing is present.

Accordingly, an object of the present invention is to provide a system capable of reliably determining whether spoofing is present by using a generative AI model to perform information retrieval based on input information and to obtain legitimate identification information of a sender, and by comparing the obtained legitimate identification information with identification information included in the received communication.

### SUMMARY

In order to achieve the above object, according to one aspect of the present invention, there is provided a system comprising a processor, wherein the processor is configured to receive information as input and generate a prompt sentence for instructing a generative AI model to perform an information retrieval based on the input information, input the generated prompt sentence to the generative AI model and obtain legitimate identification information of a sender, and determine whether spoofing is present by comparing the obtained legitimate identification information with identification information received as the input.

In one embodiment, the processor is configured to cause the generative AI model to perform the information retrieval based on the prompt sentence by using natural language processing technology and to obtain the legitimate identification information of the sender. By leveraging the natural language processing capabilities of the generative AI model, the system can flexibly interpret the prompt sentence, access relevant information sources, and extract one or more identification items, such as official sender addresses or account identifiers, that are publicly indicated as legitimate for the sender.

In another embodiment, the processor is configured to compare the obtained legitimate identification information with the identification information received as the input based on a preset matching criterion. The preset matching criterion may include, for example, exact matching, pattern-based matching, or similarity-based matching of the identification information. By performing the comparison according to the preset matching criterion, the processor can determine whether the identification information included in the received communication corresponds to legitimate identification information of the sender, and can thus determine whether spoofing is present.

The term “system” refers to an apparatus or combination of hardware and software components including at least one processor configured to execute the functions described in the claims.

The term “processor” refers to any hardware component or combination of hardware components, such as a central processing unit (CPU), microprocessor, digital signal processor, application specific integrated circuit (ASIC), field programmable gate array (FPGA), or other processing circuitry, that executes instructions to perform the claimed operations.

The term “information” refers to data included in or derived from an electronic communication, such as an email, message, or transaction, and may include, for example, a sender identifier, a recipient identifier, a subject, a message body, a header, a URL, or any other textual or structured data.

The term “identification information” refers to information that is used to identify an entity associated with an electronic communication, and may include, for example, an email address, an account identifier, a user ID, a phone number, or any other identifier indicating a sender or source.

The term “legitimate identification information” refers to identification information that is officially associated with and publicly indicated as belonging to a particular sender or entity, such as an official email address, account identifier, or other contact information disclosed by the entity through official channels.

The term “sender” refers to an entity that is purported to originate or transmit an electronic communication, such as an organization, service provider, company, or individual indicated in the identification information of the communication.

The term “spoofing” refers to an act or condition in which identification information included in an electronic communication is forged, falsified, or improperly used so as to impersonate a legitimate sender or entity.

The term “generative AI model” refers to an artificial intelligence model capable of generating text or other content in response to input, and configured to perform information retrieval or reasoning based on prompt sentences, typically using machine learning techniques such as deep learning.

The term “prompt sentence” refers to a text input generated by the processor and supplied to the generative AI model, the text input describing an instruction or query for performing information retrieval related to the input information.

The term “information retrieval” refers to a process in which the generative AI model, in response to the prompt sentence, accesses, searches, or otherwise utilizes internal knowledge or external information sources to obtain relevant data, including legitimate identification information of a sender.

The term “natural language processing technology” refers to techniques for processing, understanding, and generating human language, including but not limited to tokenization, parsing, semantic analysis, and text generation, as used by the generative AI model to interpret the prompt sentence and to perform information retrieval.

The term “preset matching criterion” refers to one or more predefined rules, thresholds, or algorithms used by the processor to determine whether identification information received as input matches legitimate identification information, the rules including, for example, exact matching, pattern matching, or similarity-based matching.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

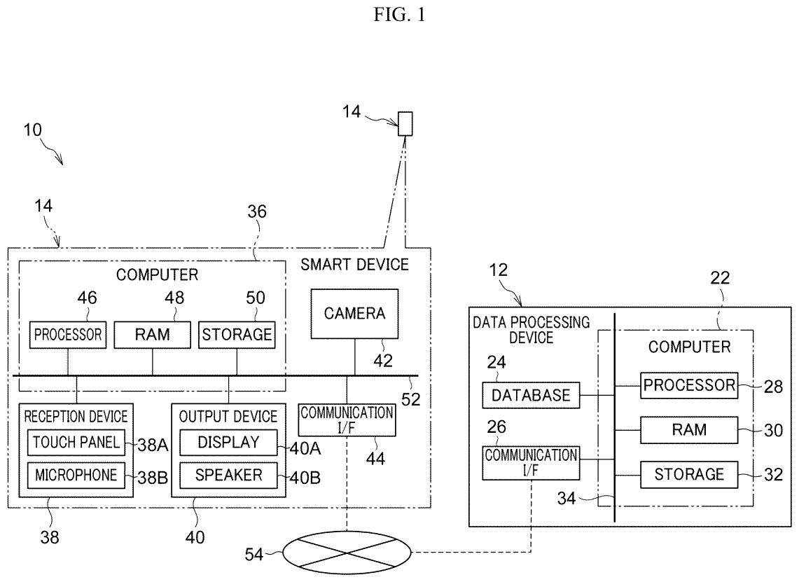

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

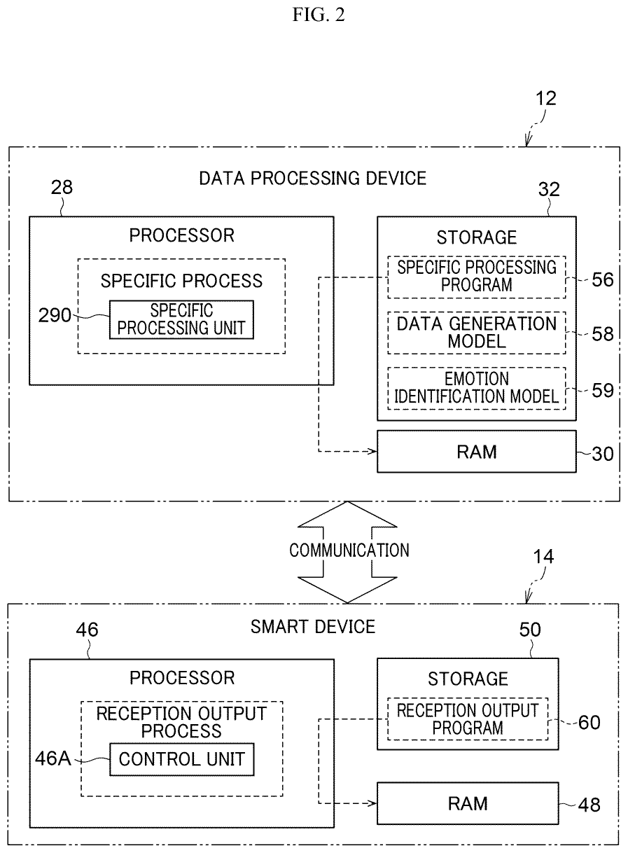

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional techniques for detecting impersonation in electronic communications (for example, electronic mail, short messages, and application notifications) rely primarily on fixed rule sets, static blacklists, and simple pattern matching against known identifiers. In such systems, a server generally compares a claimed sender identifier only against locally stored records or preconfigured policies. As a result, these systems are limited in their ability to adapt to newly emerging impersonation schemes, dynamic changes in legitimate sender information, and subtle variations in identifiers that are designed to evade static rules. This limitation leads to frequent false negatives, in which malicious impersonation communications are incorrectly treated as legitimate, and false positives, in which legitimate communications are incorrectly blocked.

Furthermore, in many existing systems, even when external information sources are consulted, the server does not effectively leverage natural language information retrieval or reasoning across heterogeneous public data. Instead, the server performs narrowly scoped lookups that do not interpret contextual content of a message, such as the text of an email body, service descriptions, or other semantic clues that could help identify the legitimate sender. This lack of semantic analysis reduces the precision and robustness of impersonation detection, especially in complex or evolving attack patterns.

In addition, conventional architectures often do not provide a systematic mechanism for refining matching criteria or similarity thresholds based on operational history. Matching thresholds are usually configured manually and remain static, which prevents the system from learning from past determinations, adapting to changing communication patterns, or systematically improving over time. Consequently, the overall computer system remains constrained in its capability to automatically calibrate itself for improved impersonation detection performance.

There is therefore a need for a technique that improves computer technology related to security assessment and filtering of electronic communications. In particular, there is a need for a server-side architecture and processing method that (i) programmatically constructs and uses prompt sentences to drive a generative AI model for external information retrieval and semantic analysis, (ii) automatically extracts legitimate identification information from natural language responses of the generative AI model, (iii) compares normalized identifiers using configurable matching and similarity criteria, and (iv) records and utilizes historical data to adjust such criteria over time. Such a technique should improve the accuracy, adaptability, and computational efficiency of impersonation detection and filtering in a networked computer system.

The specific processing by the specific processing unit 290 of the data processing device 12 in Example 1 is realized by the following means.

The present invention provides a server comprising a processor configured to receive, from a user terminal, identification information and content information as input data; generate, based on the input data, a prompt sentence that includes at least the identification information and the content information and that instructs a generative AI model, in natural language, to perform information retrieval and to return legitimate identification information of a transmission source; transmit the prompt sentence to the generative AI model via a communication network; receive, from the generative AI model, response information including the legitimate identification information of the transmission source that has been obtained using natural language processing-based information retrieval; extract the legitimate identification information from the response information; normalize the legitimate identification information and the identification information received from the user terminal; compare the normalized identification information with each other based on a predetermined matching criterion or similarity criterion to determine whether impersonation is present or absent; generate notification information representing a result of the determination and transmit the notification information to the user terminal; when the result of the determination indicates that impersonation is present, filter corresponding communication data stored in a communication apparatus or a storage apparatus and exclude the communication data from a reception area of the user terminal; and record, as history information in the storage apparatus, at least the identification information, the legitimate identification information of the transmission source, the result of the determination, and the response information from the generative AI model, and adjust at least one of the predetermined matching criterion and the similarity criterion based on the history information. This enables improvement of computer-implemented impersonation detection by tightly integrating prompt-driven generative AI-based information retrieval with server-side normalization, adaptive comparison logic, automated filtering, and feedback-based adjustment of matching parameters, thereby enhancing accuracy, adaptability, and efficiency of electronic communication security processing.

The term “system” refers to a combination of at least one hardware apparatus and at least one software component that cooperate to execute processing for detecting impersonation in electronic communications.

The term “processor” refers to a hardware processing unit, such as a central processing unit or a microcontroller, that executes instructions of a program to perform the described operations.

The term “user terminal” refers to an information processing device operated by a user, such as a personal computer, a smartphone, a tablet device, or any other communication-capable device that can transmit and receive data to and from a server.

The term “identification information” refers to data used to identify a sender or an origin of communication, such as an electronic mail address, an account identifier, a user identifier, or a network address.

The term “content information” refers to data representing the substantive content of a communication, such as a message body, a subject line, or descriptive text associated with an electronic communication.

The term “prompt sentence” refers to natural language text generated by the processor and provided as input to a generative AI model in order to instruct the generative AI model to perform information retrieval or analysis.

The term “generative AI model” refers to a machine learning model configured to generate or analyze information, including natural language text, based on input data such as prompt sentences, using techniques including, but not limited to, neural networks and natural language processing.

The term “information retrieval” refers to a process in which data relevant to a query or an instruction is obtained from one or more information sources, such as networked resources, databases, or internal knowledge representations.

The term “communication network” refers to an infrastructure that enables data transmission between devices, including at least one of a local area network, a wide area network, or a public network such as the Internet.

The term “response information” refers to data output by the generative AI model in response to a prompt sentence, the data including at least text generated based on the prompt sentence.

The term “legitimate identification information” refers to identification information that correctly represents an authorized or official sender or origin of a communication, as inferred or determined based on information retrieval or analysis.

The term “transmission source” refers to an origin entity of a communication, such as a sending account, a service provider, or a communication endpoint that transmits data to a recipient.

The term “normalize” refers to processing applied to identification information to convert the information into a standardized format, including at least one of converting character case, removing extraneous characters, and applying canonicalization rules.

The term “matching criterion” refers to a rule or a set of rules that define conditions under which two pieces of identification information are regarded as matching.

The term “similarity criterion” refers to a rule or a set of rules that define conditions under which two pieces of identification information are regarded as similar, based on a similarity measure such as an edit distance or a similarity score.

The term “impersonation” refers to an act in which a communication is made to appear as if it originates from a legitimate sender or origin when it is actually sent by an unauthorized entity.

The term “notification information” refers to data generated by the processor to inform the user terminal of a result of processing, including at least a result of a determination of whether impersonation is present or absent.

The term “communication data” refers to data representing at least part of an electronic communication, such as an email message, a message header, a message body, or associated metadata.

The term “communication apparatus” refers to a device or a system that sends, receives, or stores communication data, such as a mail server, a gateway device, or a message relay system.

The term “storage apparatus” refers to a hardware component or subsystem that stores data, such as a semiconductor memory, a magnetic storage device, an optical storage device, or a storage system including such devices.

The term “reception area” refers to a logical or physical region in which communication data for a user is stored for access, such as an inbox, a message folder, or a designated storage location on a server or a user terminal.

The term “history information” refers to data recorded over time concerning past processing, including at least identification information, legitimate identification information, determination results, and response information from the generative AI model.

The term “matching parameter” refers to data or thresholds used in applying a matching criterion or a similarity criterion, such as a minimum similarity score, an allowable difference count, or a weight assigned to components of identification information.

In one embodiment, a server constitutes a central component of a communication security system that detects impersonation in electronic communications. The server includes at least one processor, a main memory, a non-volatile storage apparatus, and one or more network interfaces. The processor may be a general-purpose central processing unit implementing an instruction set architecture such as x86-64 or ARM. The main memory may be a semiconductor memory such as a dynamic random access memory. The non-volatile storage apparatus may be a magnetic disk device, a solid-state memory device, or a redundant storage array. The network interface may be an Ethernet interface or a wireless communication interface.

The server executes an operating system such as a general-purpose server operating system and executes application software including a web server component and an application server component. For example, the web server component may be implemented by a hypertext transfer protocol server, and the application server component may be implemented by a runtime environment such as a script interpreter or a virtual machine. The server also executes program modules specific to the present invention, including a prompt generation module, a generative AI interface module, a response parsing module, a normalization and comparison module, a filtering control module, and a history management module. Each module is implemented as a set of executable instructions stored in the storage apparatus and loaded into the main memory for execution by the processor.

A terminal operates as a user-facing device and may be implemented by a personal computer, a portable information terminal, or a mobile communication device. The terminal executes an operating system and client software such as a web browser or a dedicated application. The terminal communicates with the server over a communication network using a protocol such as hypertext transfer protocol secure. A user operates the terminal to input identification information and content information to the server and to receive notification information from the server. The identification information may include an electronic mail address or another sender identifier. The content information may include a message body, a subject line, or other data representing the content of a communication.

The server processes identification information and content information using a generative AI model that is executed on a separate computing infrastructure accessible through an application programming interface. The generative AI model may be implemented as a large-scale neural network model that receives a prompt sentence as text input and produces generated text as output. The neural network model may be configured as a transformer-type architecture including multiple layers of self-attention and feed-forward sub-layers, each layer having a plurality of parameters representing connection weights and biases. The model may be trained in advance using a large corpus of text data. Training may employ a supervised learning or self-supervised learning procedure, including minimizing a loss function such as cross-entropy between predicted token distributions and ground-truth tokens. The model parameters may be optimized using a gradient-based optimization method such as stochastic gradient descent or an adaptive variant. The training data may be augmented by data augmentation techniques such as random masking, token shuffling, or subsampling of phrases.

The server uses the generative AI model in an inference mode. During inference, the processor of the server prepares a prompt sentence in natural language and transmits it to the generative AI model via the generative AI interface module. The generative AI model receives the prompt sentence and converts the text into token representations by applying a tokenization algorithm such as byte-pair encoding. The model then applies multiple attention layers to compute context-dependent feature vectors for each token, and finally generates a sequence of output tokens representing response information. The response information may include an expression of legitimate identification information of a transmission source.

The server generates the prompt sentence so that the generative AI model receives a concrete instruction to retrieve or infer legitimate identification information based on publicly available data and contextual content. The prompt sentence includes at least the identification information and the content information received from the terminal. For example, the server may generate a prompt sentence such as:
“You are a cybersecurity assistant. Using publicly available information, identify the official sender email address associated with the following email address. Consider the context of the message text. Return only the most likely official email address in plain text.
Target address: example@example.com
Email body: Hello, your account has been accessed illegally.”

In another example, the server may generate a prompt sentence such as:
“Using public information sources, determine the legitimate sender address corresponding to the following address. If the address appears to be an impersonation of another legitimate sender, return the correct legitimate sender address only.
Target address: example@example.com”

By embedding both the identification information and the content information into the prompt sentence, the server causes the generative AI model to use contextual features that conventional rule-based systems do not exploit. The server, through the generative AI interface module, transmits the prompt sentence over the communication network to the infrastructure hosting the generative AI model. The server sets control parameters such as maximum output length, temperature, and top-k sampling configuration to achieve stable and deterministic responses suitable for impersonation detection.

When the generative AI model returns response information, the server receives the response and stores it temporarily in the main memory. The response parsing module of the server performs string analysis on the response information. For example, the response parsing module applies pattern matching such as regular expression matching to detect substrings conforming to an electronic mail address pattern. If multiple candidate addresses are detected, the response parsing module applies additional heuristics, such as selecting the address that appears in a specific part of the response or selecting the first address appearing after a predetermined keyword. The parsing rules are defined explicitly, so that the extraction process is deterministic and reproducible.

The server then executes the normalization and comparison module. The normalization operation transforms both the user-provided identification information and the extracted legitimate identification information into a canonical form. For example, the server converts all characters to lower case, removes surrounding whitespace, normalizes character encoding to a single standard form, and, if needed, maps visually similar characters to a standard representative. The normalization reduces false differences due to superficial formatting, thereby improving the accuracy of comparison.

The server then compares the normalized identification information using several computational procedures. First, the server performs an exact string comparison to determine whether the identifiers are identical. Second, the server may compute a similarity metric such as Levenshtein edit distance between the identifiers. The server may compute a normalized similarity score by dividing the edit distance by the length of the longer identifier. The server may compare the resulting score against a similarity threshold stored in the storage apparatus. If the similarity score is beyond a threshold indicating meaningful difference, the server determines that the user-provided identification information is likely an impersonation of the legitimate identification information. If the similarity score indicates negligible difference, the server may consider the difference to be a minor variation.

The server records the input identification information, the extracted legitimate identification information, the computed similarity scores, and the impersonation determination result in the storage apparatus as structured history information. The history information may be stored in a relational data structure, such as a table with fields for timestamps, identifiers, model version, prompt sentence, response content, and decision outcome. The history management module accesses this data structure and periodically analyzes the distribution of similarity scores and decision outcomes. For example, the history management module may compute empirical error rates for previous thresholds and adjust the matching criteria to reduce false positives and false negatives. By updating thresholds and comparison rules based on accumulated data, the server improves the decision logic over time without manual intervention.

The server also controls interaction with communication apparatuses that handle actual message storage and delivery. For example, a communication apparatus may be an electronic mail server supporting protocols such as post office protocol or internet message access protocol. When the server determines that impersonation is present for a particular piece of communication data, the filtering control module issues appropriate commands to the communication apparatus to move or tag the corresponding communication. For example, the server may add a specific header field to the communication data indicating that the message failed impersonation checks, or may instruct the communication apparatus to move the message from an inbox folder to a quarantine folder. The server thereby causes a physical reallocation of data blocks representing the message in the storage of the communication apparatus. This cooperation between the server and the communication apparatus results in a concrete technical effect: malicious or suspicious communications are physically stored in separate areas, reducing processing load and user interface clutter in primary reception areas.

The terminal receives notification information from the server, which includes a representation of the impersonation determination result and, optionally, the extracted legitimate identification information. The terminal displays this information to the user using a graphical user interface. For example, the terminal may display messages such as “This sender address appears to be an impersonation of official@example.com” or “This sender address matches the official address and appears legitimate.” The terminal may also adjust visual indicators in the user interface, such as coloring or icons, based on the determination result. The user thus can make quicker and more reliable decisions regarding message handling, but the underlying technical processing occurs automatically on the server with improved computational procedures.

The present system improves computer technology in several ways beyond mere automation of human review. First, the use of a generative AI model controlled by structured prompt sentences and explicit parsing rules allows the server to interpret unstructured natural language content and external knowledge sources in a machine-executable way. Unlike simple keyword matching, the generative AI model internally uses high-dimensional feature representations of tokens and attention mechanisms to correlate the user-provided identification information with public descriptions of legitimate services. This correlation produces candidate legitimate identification information that conventional rule-based systems cannot reasonably derive at scale.

Second, the combination of normalization, similarity computation, and adaptive threshold adjustment enables the server to perform more precise comparison than human reviewers who rely on visual inspection. The server processes identifiers character by character, computes exact edit distances, and evaluates similarity under well-defined mathematical criteria. The history-based adjustment of matching criteria further uses machine-stored records to refine computational decision rules. As a result, the server reduces computational error rates and achieves more consistent decision outcomes, contributing to improved technical performance in security processing.

Third, by offloading semantic retrieval and inference to an external generative AI model, while keeping deterministic comparison and filtering logic on the server, the system redistributes computational workload efficiently. The server sends compact prompt sentences and receives compact text responses over the communication network instead of transferring large volumes of raw contextual data. This configuration reduces communication load compared to systems that would otherwise need to replicate large public datasets locally. The prompt design also constrains the output to a specific type of identification information, thereby minimizing processing overhead in the response parsing module.

Fourth, the architecture explicitly integrates AI-derived results with low-level control of communication apparatuses. The server does not merely label messages, but actually triggers data relocation, tagging, or access control at the storage level. This tight integration yields technical effects such as reduced processing time for searching user inboxes, improved caching efficiency due to separation of frequently accessed legitimate messages from rarely accessed suspicious messages, and reduced memory footprint in client devices due to selective synchronization of communication data.

In alternative embodiments, the server may use different generative AI models or different network architectures. For example, the generative AI model may be a recurrent neural network, a convolutional neural network, or a hybrid model, provided that it can receive prompt sentences and generate text responses. The loss function during training may include regularization terms to penalize incorrect identification suggestions. The input prompt sentence may be extended to include additional structured metadata, such as a sending internet protocol address or transport layer security certificate information, and the response parsing module may be configured to extract legitimate domains or service names instead of or in addition to email addresses.

In another variation, the normalization and comparison module may implement additional similarity measures, such as cosine similarity of character n-gram vectors or token-level similarity based on domain and local-part segmentation of addresses. The server may use a multi-stage comparison algorithm, in which a fast approximate similarity measure filters out obviously distinct identifiers and a more precise measure is applied only to borderline cases. This staged processing improves computational efficiency and reduces processor load, especially in high-volume environments.

In yet another embodiment, the history management module may employ machine learning techniques to adjust matching criteria. The server may treat historical pairs of identifiers and decision correctness as training data and update model parameters for a threshold prediction function. By updating these parameters iteratively in response to new data, the server achieves continuous adaptation to evolving impersonation patterns, which further distinguishes the invention from static rule-based approaches.

Throughout these embodiments, the server, the terminal, and the communication apparatus interact as concrete machines executing defined data structures and algorithms. The server's generation of prompt sentences, invocation of a generative AI model, deterministic parsing and normalization of responses, structured history storage, and control of communication data placement together form a specific technical solution that enhances the accuracy, speed, and computational efficiency of impersonation detection in real-world communication systems.

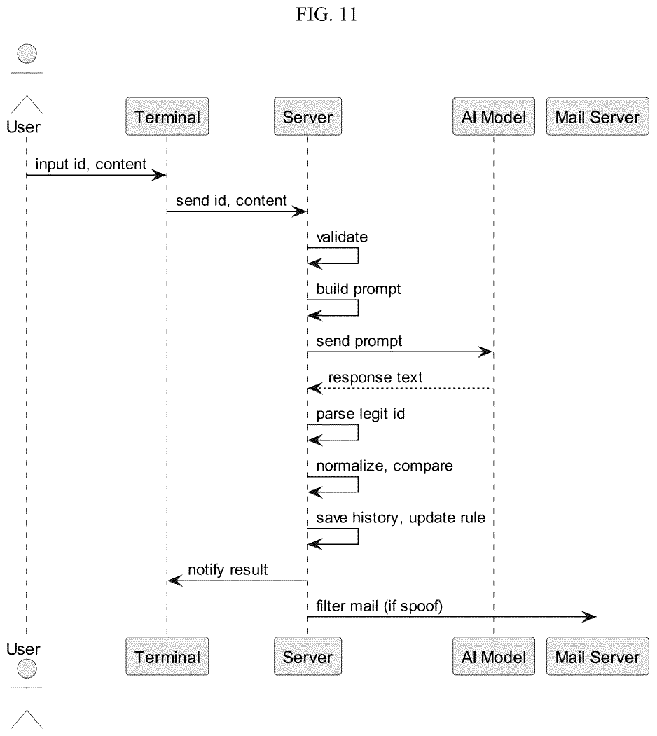

The following describes the processing flow using FIG. 11.

### Step 1:

User operates the terminal to input identification information and content information.

User views an input screen on the terminal and enters an email address or other sender identifier as identification information, and enters a message body or related text as content information. The input of this step is raw text entered by the user, and the output is a set of structured fields (for example, an identifier string and a message text string) held temporarily in the terminal's memory for transmission.

### p Step 2:

Terminal transmits the identification information and the content information to the server.

Terminal packages the identifier string and the message text string into a request object and sends the object to the server over a secure communication protocol. The input of this step is the structured fields created in Step 1, and the output is a network request that encodes these fields in a predetermined format (for example, a parameter list) and delivers them to the server through a communication interface.

### Step 3:

Server receives the request and validates the identification information and the content information.

Server accepts the network request via its network interface, decodes the transmitted data, and extracts the identifier string and the message text string. Server then performs syntax checking on the identifier string, for example by applying pattern matching rules to confirm that the string follows an address format, and checks that the content information is not empty. The input of this step is the decoded identifier and content strings, and the output is either (i) a validation success status with the extracted data stored in working memory, or (ii) a validation failure status used to generate an error response.

### Step 4:

Server generates a prompt sentence for the generative AI model based on the validated data.

Server constructs a natural language text sequence that explicitly embeds the validated identification information and content information and that instructs the generative AI model to perform information retrieval and return legitimate identification information of a transmission source. For example, the server may generate the prompt sentence:
“You are a cybersecurity assistant. Using publicly available information, identify the official sender email address associated with the following email address. Consider the context of the message text. Return only the most likely official email address in plain text.

Target address: example@example.com
Email Body: Hello, Your Account Has Been Accessed Illegally.”

The input of this step is the validated identifier and content strings, and the output is a single concatenated prompt sentence string stored in memory for subsequent transmission.

### Step 5:

Server transmits the prompt sentence to the generative AI model and requests a response.

Server invokes a generative AI interface module, embeds the prompt sentence into an inference request, and sends the request via a communication network to the computing infrastructure executing the generative AI model. The generative AI model internally tokenizes the prompt sentence, applies neural network computations, and produces a sequence of output tokens representing response information. The input of this step on the server side is the prompt sentence string, and the output is a transmitted request that causes the remote generative AI model to begin inference.

### Step 6:

Server receives response information from the generative AI model.

Server obtains the generated response text returned by the generative AI model through the generative AI interface module and stores the text in main memory. The response typically includes a candidate legitimate identification string. The input of this step is the network-level response data from the generative AI model, and the output is a response text string buffered in the server's memory and made available to the response parsing module.

### Step 7:

Server parses the response information to extract legitimate identification information.

Server applies text processing operations to the response text string to detect and extract a substring that conforms to a legitimate identifier pattern. For example, the server may apply regular expression matching to find substrings with an address-like format and may apply heuristic rules to choose the most relevant candidate. The input of this step is the raw response text string, and the output is a cleaned legitimate identification string (for example, an official sender address) stored as a distinct variable.

### Step 8:

Server Normalizes the User-provided Identification Information and the Legitimate identification information.

Server takes the original identifier string received from the terminal and the legitimate identifier string extracted from the response and converts both into a canonical format. This conversion may include lowercasing all alphabetic characters, trimming whitespace, converting to a standard character encoding, and replacing visually similar characters with canonical equivalents. The input of this step is the pair of raw identifier strings, and the output is a pair of normalized identifier strings prepared for comparison.

### Step 9:

Server compares the normalized identifier strings and computes a determination result.

Server performs data operations on the normalized identifier strings, such as executing an equality check and computing a similarity score using a string distance algorithm. Server compares the resulting values against predetermined matching and similarity criteria stored in configuration data. If the identifiers are equal or exceed a similarity threshold, the server may determine that impersonation is absent; otherwise, the server may determine that impersonation is present. The input of this step is the pair of normalized identifier strings and the threshold parameters, and the output is a determination result flag indicating presence or absence of impersonation and, optionally, an associated similarity score.

### Step 10:

Server records processing history and updates matching criteria.

Server stores the identifier strings, the extracted legitimate identifier, the determination result, and the response text into a structured history record in a storage apparatus. Server may then analyze accumulated records to compute statistics, such as error rates for previous threshold values, and may adjust the matching and similarity criteria accordingly. The input of this step is the current processing data (identifiers, result, and response) together with previously stored history, and the output is a persistent history entry and, when applicable, updated threshold parameters written back to configuration storage.

### Step 11:

Server generates notification information and transmits it to the terminal.

Server creates a structured notification message describing the determination result, and, when needed, includes the extracted legitimate identification information. Server converts this internal representation into a response format and sends it to the terminal over the communication network. The input of this step is the determination result flag, optional similarity scores, and the legitimate identifier string, and the output is a transmitted notification message that informs the terminal about whether impersonation is present or absent.

### Step 12:

Terminal receives the notification information and presents it to the user.

Terminal accepts the notification message from the server, decodes its contents, and updates a user interface component. For example, the terminal may display a warning label if impersonation is present or a confirmation label if the sender appears legitimate. The input of this step is the notification message from the server, and the output is a visual or auditory representation on the terminal that communicates the result to the user.

### Step 13:

Server controls communication data filtering based on the determination result.

Server, when the determination result indicates impersonation, issues control commands to a communication apparatus or directly manipulates message metadata in storage to move corresponding communication data to a quarantine region or to tag it with a failure indicator. The input of this step is the determination result and identifiers associated with specific communication data, and the output is a modified storage state in which impersonation-related messages are excluded from primary reception areas, thereby altering subsequent access behavior for the terminal and the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In networked communication environments, such as electronic messaging systems, conventional spoofing-detection techniques typically rely on static rule sets, blacklist or whitelist databases, and simple string-based domain checks. These techniques are often implemented as fixed logic within security gateways or client applications, and they are limited in their ability to interpret evolving attack patterns, newly registered domains, or subtle impersonations that exploit natural language content. As a result, such conventional techniques frequently generate false positives and false negatives, which degrade the reliability of automated classification and force human operators to manually review large volumes of messages.

Furthermore, conventional systems are not designed to dynamically leverage external public information sources at runtime in a context-aware manner. Even when public information, such as official domains or contact addresses, is available on external information resources, existing spoofing-detection mechanisms generally do not retrieve, normalize, and compare such information on a per-message basis in real time. Instead, they depend on periodically updated static datasets, which quickly become outdated as organizations change their contact policies or as malicious entities register confusingly similar domains.

In addition, existing systems do not fully exploit advances in natural language processing technology. While generative models and related technologies are capable of synthesizing and structuring information derived from large-scale corpora, conventional security systems rarely integrate such models into an automated decision flow. As a result, current systems are unable to automatically generate rich explanation information about why a given message is suspected to be an impersonation, nor can they adapt their comparison criteria based on nuanced textual context in the communication content itself.

Another technical problem is that, in many implementations, the client-side application or user terminal performs only coarse-grained filtering (for example, moving messages to a generic spam folder) based on limited header information. These implementations do not provide a coordinated mechanism in which a server-side information processing apparatus performs advanced, model-driven analysis, produces structured determination information with confidence values, and then instructs the user terminal precisely how to classify and store messages in different storage areas. This lack of coordinated control reduces the accuracy and transparency of classification from the viewpoint of both system performance and user experience.

There is also a need to systematically record impersonation determination results together with associated reliability information and identifiers in a storage apparatus. Conventional systems do not consistently maintain such structured historical records, thereby limiting their ability to audit past determinations, to refine detection criteria based on user feedback, or to analyze the long-term behavior of impersonation attempts. Without a persistent, structured record linked to concrete identifiers and time information, it is difficult to improve the underlying algorithms or to demonstrate the operational behavior of the system in a verifiable manner.

Accordingly, there is a need for an improved computer-implemented technique that: (i) dynamically generates a prompt sentence tailored to each incoming message; (ii) utilizes a generative AI-type model as a natural language processing engine to retrieve or infer legitimate identification information and explanation information from public information sources; (iii) performs a structured comparison between a sender identifier and a legitimate identifier using both exact and similarity-based evaluation; (iv) provides machine-readable determination information and classification instruction information to a user information processing apparatus for precise storage-area control; and (v) records impersonation determination results with associated reliability information in a storage apparatus for subsequent analysis and refinement. Such a technique would constitute an improvement in computer technology by enhancing the accuracy, adaptability, and explainability of automated spoofing detection and classification in communication systems.

The specific processing by the specific processing unit 290 of the data processing device 12 in Application Example 1 is realized by the following means.

The present invention provides a server comprising a processor configured to receive, via a communication interface, input information including a sender identifier and communication content information from a user information processing apparatus; to generate, based on the sender identifier and the communication content information, a prompt sentence that specifies a content of an information retrieval process to be executed by a generative information processing model; to input the prompt sentence into the generative information processing model and thereby cause the generative information processing model to acquire, from at least one public information source, legitimate identification information corresponding to a sender and explanation information related to the legitimate identification information; to obtain the legitimate identification information and the explanation information as structured data; to extract, from the structured data, a legitimate identifier; to compare the legitimate identifier with the sender identifier included in the input information, based on a determination criterion including a character string comparison process and a similarity calculation process, and to generate an impersonation determination result and reliability information associated with the impersonation determination result; to generate determination information including at least the impersonation determination result and the explanation information, and to transmit the determination information as notification information to the user information processing apparatus; to generate classification instruction information for causing the user information processing apparatus to classify message information corresponding to the communication content information into a suspicious message storage area among storage areas of the user information processing apparatus, in accordance with the impersonation determination result, and to transmit the classification instruction information to the user information processing apparatus; and to record the impersonation determination result and the reliability information in a storage apparatus in association with an identifier and time information. This enables an improved computer-implemented spoofing-detection and message-classification technique in which a generative AI-based natural language processing engine is tightly integrated with server-side comparison logic and client-side storage control, thereby enhancing the accuracy, adaptability, and explainability of automated impersonation determination in networked communication systems.

The term “processor” refers to a hardware or virtual computation unit, such as a central processing unit or a processing core in an information processing apparatus, that executes instructions of a program to perform logical, arithmetic, control, and input/output operations.

The term “system” refers to an arrangement including at least one information processing apparatus, at least one user information processing apparatus, and at least one communication apparatus, which cooperate to execute spoofing detection and message classification processing.

The term “information processing apparatus” refers to an electronic device, such as a server or computing node, equipped with a processor, a memory, and a communication interface, and configured to execute predetermined information processing, including generation of prompt sentences, interaction with a generative information processing model, and impersonation determination.

The term “user information processing apparatus” refers to an electronic device operated by a user, such as a terminal, client device, or communication endpoint, which transmits input information including a sender identifier and communication content information to the information processing apparatus and receives determination information and classification instruction information.

The term “communication apparatus” refers to a hardware or software communication interface, such as a network interface card, modem, or communication module, that enables data transmission between the information processing apparatus and the user information processing apparatus over a communication network.

The term “input information” refers to information transmitted from the user information processing apparatus to the information processing apparatus, including at least a sender identifier and communication content information associated with a message.

The term “sender identifier” refers to identification information that specifies an originator of a message, such as an electronic address, communication account identifier, or other sender-side identifier included in message metadata.

The term “communication content information” refers to data representing a body of a message, such as text, structured data, or other payload content that conveys information from a sender to a recipient.

The term “prompt sentence” refers to a text or structured instruction sequence generated by the processor, which defines a content and context of an information retrieval process or analysis to be executed by a generative information processing model.

The term “generative information processing model” refers to a machine learning model, such as a generative artificial intelligence model based on natural language processing, that generates or retrieves information in response to an input prompt sentence.

The term “information retrieval process” refers to a process in which the generative information processing model acquires or infers information, such as legitimate identification information and explanation information, from one or more public information sources or from its learned parameters based on the prompt sentence.

The term “public information source” refers to an information resource available to the general public, such as a database, a network-accessible information service, or a published document, that can be used to obtain legitimate identification information related to an entity.

The term “legitimate identification information” refers to identification information that is officially associated with a true sender or entity, such as an authorized domain, an official contact address, or a registered identifier corresponding to the sender.

The term “legitimate identifier” refers to an identifier, such as a domain name or address, that is extracted from the legitimate identification information and used as a reference for comparison with the sender identifier.

The term “explanation information” refers to descriptive information, generated or obtained via the generative information processing model, that explains why certain identification information is considered legitimate or why a message is determined as an impersonation or non-impersonation.

The term “structured data” refers to data formatted in a machine-readable structure, such as a key-value representation, a hierarchical object structure, or a tabular format, which enables programmatic extraction of elements including legitimate identifiers and explanation information.

The term “determination criterion” refers to one or more rules, thresholds, or algorithms used to evaluate a relationship between the sender identifier and the legitimate identifier, including a character string comparison process and a similarity calculation process.

The term “character string comparison process” refers to a process in which sequences of characters, such as sender identifiers and legitimate identifiers, are compared using operations such as equality checks, normalization, or pattern matching.

The term “similarity calculation process” refers to a process that computes a degree of similarity between two or more character strings or identifiers, using, for example, distance metrics, similarity scores, or pattern-based evaluations.

The term “impersonation determination result” refers to information indicating whether a message or sender identifier is determined to represent an impersonation attempt, a non-impersonation, or another classification derived from the comparison between the sender identifier and the legitimate identifier.

The term “reliability information” refers to information indicating a degree of confidence, probability, or reliability associated with the impersonation determination result.

The term “determination information” refers to information generated by the processor that includes at least the impersonation determination result and the explanation information, and that is transmitted to the user information processing apparatus.

The term “notification information” refers to determination information or related data transmitted from the information processing apparatus to the user information processing apparatus for presentation or further processing.

The term “message information” refers to data representing a message managed by the user information processing apparatus, including at least a sender identifier and communication content information.

The term “storage area” refers to a logical or physical region in a storage apparatus of the user information processing apparatus, allocated for storing messages or related information.

The term “suspicious message storage area” refers to a storage area among storage areas of the user information processing apparatus that is designated for storing messages determined as impersonation attempts or otherwise suspicious.

The term “classification instruction information” refers to information transmitted from the information processing apparatus to the user information processing apparatus, instructing the user information processing apparatus to classify and store message information in a particular storage area, including a suspicious message storage area.

The term “storage apparatus” refers to a hardware or virtual storage device, such as a memory, disk, or database, that stores impersonation determination results, reliability information, identifiers, time information, and other data.

The term “identifier” refers to information used to uniquely or distinctively identify a message, a record, or another entity within the system, such as a message ID, record ID, or session ID.

The term “time information” refers to data indicating a time point or period, such as a timestamp or time interval, associated with processing of a message, recording of a determination result, or another system event.

In one embodiment, a server implements an impersonation-detection and message-classification system by executing a program on a hardware platform that includes at least one central processing unit (CPU), a main memory, a non-volatile storage device, and a network interface. The server uses a general-purpose operating system such as a UNIX-based system and runs an application layer implemented, for example, using a web framework such as Flask or FastAPI in a Python environment or Express in a JavaScript environment. The server stores configuration data, log data, and impersonation determination records in a storage system such as a relational database management system.

The server cooperates with at least one terminal operated by a user. The terminal is, for example, a smartphone, a tablet, a notebook computer, or a desktop computer. The terminal executes a mail client application or a dedicated security client application on top of an operating system such as a mobile operating system or a desktop operating system. The terminal connects to a mail server via standard protocols to receive electronic messages, and connects to the server via an encrypted network connection such as HTTPS to request impersonation determination.

The server uses a generative AI model as a generative information processing model. The generative AI model is implemented as a neural network, for example, a transformer-based language model that includes multiple attention layers, feed-forward layers, embedding layers, and layer normalization units. The server accesses the generative AI model via an application programming interface exposed by a model-serving system. The model-serving system may run locally on the same hardware as the server or on a remote computing infrastructure. The server specifies a model identifier, such as a particular transformer configuration with a defined number of layers, hidden units, attention heads, and vocabulary size, and provides a prompt sentence to the model as an input sequence of tokens.

The server stores in memory a configuration for the generative AI model, including parameters such as a temperature parameter controlling sampling diversity, a maximum token length for outputs, and constraints on output format. The server uses these parameters to obtain output text from the generative AI model that is suitable for structured analysis. The generative AI model processes the input prompt sentence by applying a series of matrix multiplications and non-linear activations to compute contextualized token representations and to generate output tokens that form a natural language response including legitimate identification information and explanation information.

The terminal manages message data in a structured data format. The terminal stores each message as a record in a local storage structure or in a synchronized remote mailbox, the record including at least a message identifier, a sender identifier, header information, and communication content information. The terminal also maintains multiple storage areas, including an inbox, an archive, and a suspicious message storage area. The terminal associates each message with a storage area and updates this association based on classification instruction information received from the server.

The server maintains several software modules, including an input reception module, a prompt generation module, a model interaction module, a parsing and comparison module, a determination and logging module, and an instruction generation module. The server implements each module as a set of executable routines that operate on data structures defined in the server memory. The server stores the program for these modules on the storage device and loads the program into memory for execution by the CPU.

The server receives, via the input reception module, input information from the terminal. The input information includes a sender identifier and communication content information for a particular message. The server represents this input information as a structured object in memory, for example, an internal record that stores the sender identifier as a normalized character string and the communication content information as a text string or as a sequence of tokens. The server may also store auxiliary attributes such as a message identifier, a reception timestamp, and network-origin information.

The server uses the prompt generation module to construct a prompt sentence for the generative AI model. The server stores one or more prompt templates in memory as text patterns with placeholders. The server replaces placeholders with specific values from the input information, such as the sender identifier and excerpts from the communication content information. Through this replacement operation, the server creates a concrete prompt sentence that instructs the generative AI model to perform an information retrieval process regarding legitimate identification information and to generate explanation information.

The server, in one example, generates a prompt sentence of the following form: “Please verify if the email address ‘example@trusted.com’ is the legitimate address for the company ‘Trusted Corp’. Also, based on the following email text, evaluate whether this message is likely to be an impersonation attempt: [EMAIL_BODY_HERE]. Return the official contact email domains of the company and a short explanation.”

The server may also generate a more detailed prompt sentence for structured analysis, such as:
“Act as a cybersecurity assistant. Given the sender address ‘hr@trusted-corp.com’ and the following email content: ‘[EMAIL_BODY]’, determine whether this email is likely to be an impersonation of the corresponding organization. First, identify legitimate domains and official contact addresses of the organization from public information. Then compare them with ‘hr@trusted-corp.com’ and explain your reasoning step by step.”

The server encodes the prompt sentence as a sequence of tokens using a tokenizer associated with the generative AI model. The server sends these tokens over the network interface to the model-serving system. The generative AI model computes attention weights, intermediate feature representations, and probability distributions over output tokens, and the model-serving system returns an output sequence to the server. The server decodes the output sequence into a natural language response.

The server obtains the output as structured data by constraining the generative AI model via the prompt sentence or by post-processing the output. The server, for example, instructs the model to list legitimate domains and official addresses in a structured text format, such as labeled lines or a delimited list. The server parses the output text using syntax rules and pattern-matching operations to extract fields such as legitimate domains, official contact addresses, and explanation sentences. The server stores these extracted elements in an internal data structure, such as a record with arrays of character strings for domains and a text field for explanation information.

The server normalizes the sender identifier and the legitimate identifiers to a common representation. The server, for example, converts all characters to lowercase, removes extraneous whitespace and punctuation, and validates character sets. The server then uses the parsing and comparison module to compare the normalized sender identifier with each legitimate identifier. The server performs a character string comparison process to detect exact matches and performs a similarity calculation process to detect near matches. The server may use algorithms such as edit-distance calculations or token-based similarity scores to quantify the similarity between domain strings or address strings.

The server computes a similarity score for each comparison and aggregates these scores according to a determination criterion. The server may, for example, determine that the sender identifier is legitimate when the maximum similarity score exceeds a threshold and none of the similarity patterns match known impersonation features. The server may determine that the sender identifier represents an impersonation when the similarity score is below the threshold but the legitimate identifiers correspond to an entity referenced in the communication content information. The server may also combine the similarity scores with additional features, such as the presence of suspicious phrases in the communication content information, to improve detection accuracy.

The server generates an impersonation determination result and reliability information in the determination and logging module. The server quantifies the reliability information based on similarity scores, completeness of legitimate identification information, and consistency of the generative AI model output. The server stores the impersonation determination result, the reliability information, the sender identifier, and time information as a record in the storage apparatus. The server may assign a unique identifier to each record and index the storage by this identifier and timestamp to support later retrieval and analysis.

The server generates determination information that includes at least the impersonation determination result and the explanation information derived from the generative AI model output. The server may also include the normalized legitimate identifiers and relevant scores. The server transmits this determination information to the terminal as notification information via the communication interface. The terminal receives the notification information, parses the determination information, and updates its user interface to present the impersonation determination result and explanation information to the user.

The server generates classification instruction information for the terminal. The classification instruction information indicates a target storage area for the message, for example, the suspicious message storage area when the impersonation determination result indicates a likely impersonation. The server transmits the classification instruction information to the terminal, which then moves or reassigns the corresponding message to the specified storage area. The terminal, for instance, updates a local database or an index that associates each message identifier with a storage area name and sends appropriate commands to a mail server when synchronization is required.

The user operates the terminal to view messages and determination information. The terminal displays a list of messages and visually distinguishes messages stored in the suspicious message storage area. The terminal displays, on demand, detailed explanation information that the server generated based on the generative AI model output. The terminal may provide an interface element enabling the user to correct the impersonation determination result by marking a message as trusted or as fraudulent. The server can receive such corrections and incorporate them into future processing, for example, by adjusting determination criteria or by augmenting training data used for further model refinement.

The server achieves technical improvements over conventional systems by processing large-scale external information and natural language content in a structured, model-driven manner. The server does not merely automate a human rule-based check; rather, the server integrates a neural network architecture that has been trained on extensive text corpora and optimized using a learning algorithm such as stochastic gradient descent with an error function such as cross-entropy loss. During training, the generative AI model has adjusted its weight parameters to minimize prediction error across a massive dataset, which enables the server to leverage distributed representations that capture subtle relationships between organization names, domains, and natural language descriptions.

The server, by generating specific prompt sentences that encode the sender identifier and communication context, causes the generative AI model to activate internal feature patterns corresponding to organizational identity and domain usage. This generative processing allows the server to infer legitimate identifiers and explanation information even for entities not explicitly stored in a local ruleset or database. Because the model operates on vectorized feature representations, the system improves detection accuracy over static string-matching approaches, especially for newly observed domains and obfuscated impersonations.

The server improves computational efficiency by normalizing inputs and restricting the length of communication content information before generating a prompt sentence, thereby reducing the number of tokens processed by the generative AI model and limiting resource consumption. The server improves data management by storing not only binary impersonation determinations but also associated reliability information, structured legitimate identifiers, and explanation information, enabling later auditing and statistical optimization. The server can analyze historical records to identify patterns in impersonation attempts and to adjust thresholds in the determination criterion, which leads to reduced false positives and false negatives in subsequent operation.

The server also reduces communication load by transmitting concise determination information and classification instruction information to the terminal instead of full model outputs or large datasets. The terminal does not need to access external public information sources or interact with the generative AI model directly; thus, overall network traffic and client-side computation are reduced. This division of processing responsibilities constitutes an improvement in system-level architecture.

The system differs from conventional human review by employing non-intuitive comparison strategies. The server, for example, applies a combination of similarity metrics across multiple tokenization schemes, such as character-level and subword-level comparisons, and may weight these metrics according to statistical analysis of historical impersonation cases. The server may also implement a non-linear decision function that integrates similarity scores, content-based risk indicators, and generative AI model confidence descriptors. These mechanisms define a computational procedure that a human reviewer does not typically perform manually and that cannot be reduced to a simple automation of human judgment.

In alternative embodiments, the server may use different generative AI models with varied architectures and training methods. The server may use a sequence-to-sequence model with encoder-decoder structure, a recurrent neural network with gated units, or a hybrid model incorporating convolutional layers for character-level feature extraction. The server may also employ models fine-tuned on a domain-specific dataset of organizational communication patterns, using supervised learning and data augmentation methods such as synonym substitution, domain variant generation, and template-based paraphrasing. The server may maintain multiple models and select an appropriate model based on message language, domain category, or risk level.

In another embodiment, the terminal may provide additional local processing. The terminal may implement a lightweight heuristic pre-filter to decide when to request a full impersonation determination from the server, thus reducing the number of requests for low-risk messages. The terminal may also store a local cache of recent classification instruction information and apply similar classification to related messages without invoking the generative AI model via the server, further reducing computation and network usage. The server can still provide high-resolution determinations with explanation information when necessary.

Through these embodiments, the server, the terminal, and the user cooperate to realize a system that uses a generative AI model and precisely generated prompt sentences to detect impersonations and to control message storage areas. The use of neural network-based generative processing, explicit similarity calculation, structured logging, and coordinated client-server classification instruction results in a technical improvement in the speed, accuracy, and manageability of impersonation detection in communication networks.

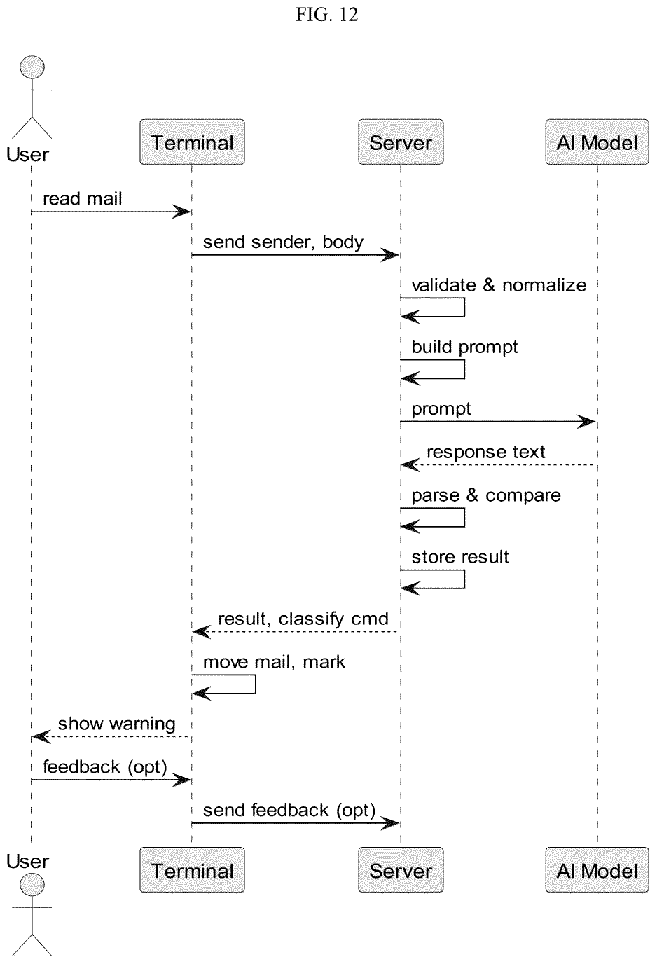

The following describes the processing flow using FIG. 12.

### Step 1:

The terminal acquires a new message from a message server or local storage and extracts a sender identifier and communication content information. The input to this step is a raw message including header fields and a message body. The terminal parses the header to obtain the sender identifier, parses the body to obtain the communication content information, and generates an internal message record including a message ID, the sender identifier, and the communication content information as output.

### Step 2:

The terminal prepares and sends input information to the server via a secure network connection. The input to this step is the internal message record created in Step 1. The terminal constructs a request object containing at least the message ID, the sender identifier, and the communication content information, serializes the request object into a structured format such as JSON, and transmits the serialized data to the server over HTTPS. The output of this step is the transmitted request received at the server side.

### Step 3:

The server receives and validates the input information from the terminal. The input to this step is the structured request sent in Step 2. The server deserializes the request, extracts the message ID, the sender identifier, and the communication content information, and performs validation checks such as format verification, length limits, and character set normalization. The server outputs a normalized internal input structure containing validated sender identifier and communication content information associated with the message ID.

### Step 4:

The server generates a prompt sentence for the generative AI model based on the normalized input structure. The input to this step is the normalized internal input structure from Step 3. The server selects a prompt template stored in memory, inserts the sender identifier and a truncated or preprocessed version of the communication content information into the template, and concatenates static instruction text with dynamic values. The server outputs a concrete prompt sentence expressed in natural language and suitable for submission to the generative AI model.

### Step 5:

The server invokes the generative AI model with the generated prompt sentence. The input to this step is the concrete prompt sentence produced in Step 4. The server tokenizes the prompt sentence into a sequence of tokens using a tokenizer associated with the generative AI model, sends the token sequence and model configuration parameters (such as maximum output length and temperature) to a model-serving system, and waits for the model to generate an output sequence of tokens. The server decodes the output token sequence back into natural language text. The output of this step is a model response text that includes legitimate identification information and explanation information.

### Step 6:

The server parses the model response text and extracts legitimate identifiers and explanation information. The input to this step is the model response text from Step 5. The server applies pattern-matching rules or a parsing grammar to identify portions of the text corresponding to legitimate domains, official addresses, and narrative explanation. The server normalizes these elements by converting to a canonical form (for example, lowercasing domains and removing whitespace). The server outputs a structured data object containing at least one legitimate identifier and associated explanation information.

### Step 7:

The server compares the sender identifier with the legitimate identifiers using a determination criterion. The input to this step is the normalized sender identifier from Step 3 and the structured data object with legitimate identifiers from Step 6. The server decomposes each identifier into components such as local part and domain, performs exact string comparison on normalized forms, and then applies similarity calculation algorithms (for example, edit distance or token overlap) to compute one or more similarity scores. The server aggregates the scores and applies threshold logic defined in the determination criterion. The output of this step is an impersonation determination result indicating impersonation or non-impersonation and a numerical reliability value representing confidence.

### Step 8:

The server generates determination information and classification instruction information for the terminal. The input to this step is the impersonation determination result and reliability value from Step 7, along with the explanation information extracted in Step 6 and the message ID. The server constructs a determination information object including the impersonation determination result, the reliability value, the explanation information, and optionally the normalized legitimate identifiers. The server also constructs classification instruction information indicating a target storage area, for example, a suspicious message storage area when the impersonation determination result is positive. The output of this step is a combined response structure containing determination information and classification instruction information associated with the message ID.

### Step 9:

The server records the impersonation determination result and related metadata in a storage apparatus and transmits the response to the terminal. The input to this step is the combined response structure from Step 8. The server writes a record to persistent storage, associating the message ID, the sender identifier, the impersonation determination result, the reliability value, and time information. The server then serializes the combined response structure into a network message and sends it over HTTPS to the terminal. The output of this step is a stored determination record and a transmitted response received by the terminal.

### Step 10:

The terminal receives and interprets the determination information and classification instruction information from the server. The input to this step is the response transmitted in Step 9. The terminal deserializes the response, retrieves the determination information and classification instruction information, and matches the message ID in the response with a local message record. The terminal updates local metadata for the corresponding message to store the impersonation determination result, reliability value, and explanation text. The output of this step is an updated local message database where each message now carries server-provided determination attributes.

### Step 11:

The terminal classifies the message into an appropriate storage area based on the classification instruction information. The input to this step is the updated local message record and the classification instruction information from Step 10. The terminal modifies internal indices or message flags to move or reassign the message from an original storage area, such as an inbox, to a target storage area, such as a suspicious message storage area, when the instruction so indicates. The terminal may also update synchronization metadata to propagate this classification to a remote message server. The output of this step is a new mapping between the message and a storage area reflecting the impersonation determination.

### Step 12:

The terminal presents the impersonation determination result and explanation information to the user. The input to this step is the updated message database, including determination attributes and storage-area assignments from Steps 10 and 11. The terminal renders a user interface that visually distinguishes suspicious messages, for example by placing them in a specific list or by adding warning indicators. The terminal retrieves the explanation information for a selected message and displays it in a detailed view when the user opens the message. The output of this step is a graphical or textual display on the terminal that informs the user about the impersonation determination and the reasoning behind it.

### Step 13:

The user reviews the displayed information and optionally provides feedback or corrective input. The input to this step is the user interface presented by the terminal in Step 12. The user reads the explanation, evaluates whether the classification appears correct, and may operate input controls to mark a suspicious message as trusted or to report a non-suspicious message as impersonation. The output of this step is user feedback data, such as a correction flag or classification override, captured by the terminal.

### Step 14:

The terminal transmits user feedback to the server for possible adjustment of future determinations. The input to this step is the user feedback data from Step 13 and the related message identifier. The terminal packages this feedback into a structured feedback request and sends it to the server via HTTPS. The terminal may also update local flags to reflect the corrected classification immediately. The output of this step is a feedback request received by the server and an updated local classification state.

### Step 15:

The server records and utilizes the user feedback to refine determination behavior. The input to this step is the feedback request from Step 14. The server stores the feedback in the storage apparatus, associating it with the original impersonation determination result and reliability value. The server may analyze accumulated feedback to adjust similarity thresholds, to modify prompt sentence templates, or to update configuration parameters for invoking the generative AI model. The output of this step is an updated set of determination parameters or configuration data that influence subsequent impersonation determinations, improving accuracy and reducing errors over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional spoofing detection techniques in networked communication environments largely rely on static rule sets, manually curated blacklists, or limited pattern-matching against locally stored reference data. Such approaches require frequent manual updates, do not scale well to newly emerging spoofing patterns, and often fail to correctly identify spoofed source identification information that mimics legitimate identifiers with minor variations. In many cases, conventional systems either generate excessive false positives, which degrade user experience and trust, or fail to detect sophisticated spoofing attempts, which compromises security of end users and organizations.

Furthermore, existing systems typically perform their analysis only on data locally available to a given server or client device, without dynamically leveraging up-to-date information distributed over public information networks. As a result, these systems cannot adequately confirm whether a given source identifier is legitimately associated with an entity at the time of communication, and they cannot automatically adapt when official contact channels, domains, or identifiers change.

In addition, known spoofing detection mechanisms usually treat each communication item in isolation and do not provide a robust mechanism for classifying detected spoofed information into categories and automatically controlling storage locations or display formats based on such classification. This lack of integrated classification and handling causes inefficiencies in downstream processing, such as user notification, quarantine, and prioritization of security review.

From a computer-technology perspective, there is a need to improve how a processor orchestrates multiple heterogeneous software components—such as a generative artificial intelligence model, information browsing software, and comparison algorithms—to perform coordinated data acquisition, analysis, and classification. Traditional architectures do not define how to combine generative AI-based information retrieval with browser-driven access to public information sources to dynamically obtain legitimate source identification information and compare it against incoming identifiers in a computationally efficient and automated manner.

Accordingly, a technical problem to be solved is to provide an improved computer-implemented system and processing architecture that: (i) automatically generates a prompt sentence and cooperates with a generative AI model to guide information retrieval; (ii) uses information browsing software to obtain candidate legitimate source identification information from public information networks in real time; (iii) performs structured comparison between received and legitimate identifiers using string-based algorithms; and (iv) automatically classifies and handles spoofed information by controlling storage locations and display formats. This computer-technical improvement should reduce manual maintenance of rules, enhance detection accuracy for spoofed identifiers, and increase processing efficiency and automation within the server-side infrastructure.

The specific processing by the specific processing unit 290 of the data processing device 12 in Example 2 is realized by the following means.

The present invention provides a server comprising a processor configured to receive, from an external device via a communication path, source identification information and information related to the source identification information as input data; generate a prompt sentence, based on the received source identification information and the related information, for instructing a generative artificial intelligence model to perform information retrieval; input the generated prompt sentence into the generative artificial intelligence model; control an information acquisition process for searching public information sources based on a response obtained from the generative artificial intelligence model; acquire candidate information including legitimate source identification information by using information browsing software operating on an information providing apparatus connected via a network; extract the legitimate source identification information from the candidate information; compare the extracted legitimate source identification information with the received source identification information based on a character string comparison algorithm or a similarity calculation algorithm; determine whether spoofing is present according to a comparison result; generate notification information indicating a determination result regarding the presence or absence of spoofing and the legitimate source identification information; transmit the notification information to the external device; classify information associated with spoofing, when it is determined that spoofing is present, based on a predefined classification criterion; and control a storage location or a display format of the information according to a classification result. This enables improved computer-implemented spoofing detection in which the server dynamically coordinates a generative AI model and browser-based information retrieval to obtain up-to-date legitimate source identification information, performs structured algorithmic comparison against received identifiers, and automatically classifies and manages spoofed information at the system level, thereby enhancing detection accuracy, reducing manual rule maintenance, and improving processing efficiency and automation in a networked communication environment.

The term “system” refers to a combination of hardware and software components that cooperate to execute one or more information processing operations, including at least one processor and associated functional modules.

The term “processor” refers to a hardware execution unit, such as a central processing unit or a processing core, capable of executing instructions to perform logical, arithmetic, control, and input/output operations required for implementing the claimed functions.

The term “external device” refers to an information processing apparatus, such as a client terminal or user device, that is separate from the server and communicates with the server via a communication path to send input data and receive output data.

The term “communication path” refers to any wired or wireless communication medium, protocol, or network infrastructure that enables transmission of data between the server and an external device, including local area networks, wide area networks, and public communication networks.

The term “source identification information” refers to data that identifies a source of communication, such as an address, identifier, or account name, used to distinguish a particular sender or origin of information.

The term “information related to the source identification information” refers to content or metadata associated with the source identification information, including message bodies, headers, subject lines, timestamps, attachments, or any other contextual data.

The term “prompt sentence” refers to a sequence of characters or words, typically expressed in natural language, that is generated by the processor to instruct a generative artificial intelligence model to perform a specific processing operation, such as information retrieval.

The term “generative artificial intelligence model” refers to a trained machine learning model, such as a large language model, that uses artificial intelligence techniques to generate or transform data, including natural language responses, based on input such as a prompt sentence.

The term “information retrieval” refers to a process of searching for, accessing, and obtaining relevant data from one or more information sources, including public information networks and databases, in response to a query or instruction.

The term “public information sources” refers to data repositories or information resources that are accessible over a public information network, such as web pages, online databases, or other publicly available content.

The term “information acquisition process” refers to a sequence of operations controlled by the processor to obtain candidate information from one or more information sources, including generation of search queries, invocation of browsing functions, and extraction of relevant data.

The term “information browsing software” refers to a software program that retrieves, renders, and displays information from information sources over a network, including web browsers or equivalent screen display control programs.

The term “information providing apparatus” refers to an information processing apparatus, such as a server or networked computer, that supplies information via a network to the information browsing software under control of the processor.

The term “network” refers to a communication infrastructure, including hardware and protocols, that enables data exchange between multiple information processing apparatuses, such as the Internet or other interconnected communication systems.

The term “candidate information” refers to information obtained from public information sources that potentially includes or is associated with legitimate source identification information corresponding to a given sender or origin.

The term “legitimate source identification information” refers to source identification information that is officially recognized or authorized for use by an entity as a correct and genuine identifier, such as an official address or account identifier.

The term “character string comparison algorithm” refers to a computational procedure used to compare two or more sequences of characters to determine equality or difference according to predefined rules.

The term “similarity calculation algorithm” refers to a computational procedure that calculates a degree of similarity between two or more sequences of characters or identifiers, using metrics such as edit distance, pattern matching, or other similarity measures.

The term “comparison result” refers to data representing an outcome of applying a character string comparison algorithm or a similarity calculation algorithm to at least two pieces of source identification information.

The term “spoofing” refers to an act or condition in which source identification information is falsified or misused such that a sender or origin is made to appear as a different legitimate entity.

The term “determination result regarding the presence or absence of spoofing” refers to an output indicating whether spoofing is judged to be present or not present based on a comparison result and associated evaluation criteria.

The term “notification information” refers to data generated by the processor to inform an external device about a determination result regarding spoofing, and optionally about corresponding legitimate source identification information or recommended actions.

The term “predefined classification criterion” refers to one or more rules, conditions, or parameters, previously established in the system, that specify how information associated with spoofing is to be categorized.

The term “information associated with spoofing” refers to communication data, metadata, or related content that is determined to be linked to a spoofing event, including messages, identifiers, and context information.

The term “storage location” refers to a logical or physical area within one or more storage devices where information is recorded, such as folders, directories, mailboxes, or database records.

The term “display format” refers to a visual representation or layout used by a user interface to present information, including aspects such as color, icons, warnings, grouping, or display region.

The term “classification result” refers to data indicating a category or label assigned to information associated with spoofing after evaluation according to a predefined classification criterion.

The term “screen display control program” refers to software that controls rendering and interaction of user interface elements, including the display of retrieved information from a public information network on a display device.

The term “general-purpose information processing apparatus” refers to an information processing system capable of executing a variety of software programs not limited to a single dedicated application, such as a personal computer or general server.

The term “search query” refers to one or more terms, phrases, or expressions generated by the processor and supplied to information browsing software or a search function to retrieve relevant information from public information sources.

The term “public information network” refers to a network infrastructure that allows access to publicly available information resources, including, for example, the global Internet.

The term “information resources” refers to data objects or content accessible over a network, including documents, web pages, records, and other structured or unstructured information.

The term “unauthorized communication information” refers to communication data that is identified as originating from an unauthorized or untrusted source, including messages associated with spoofing or other illicit activities.

The term “advertising information” refers to communication data whose primary purpose is promotion or marketing of products, services, or content, regardless of whether it is solicited or unsolicited.

The term “suspicious transaction information” refers to communication data that is associated with or suggests potentially fraudulent, unauthorized, or unusual transactional activities.

The term “storage area” refers to a designated logical partition or region within a memory or storage system where particular categories of information are stored.

The term “display area” refers to a designated region of a display screen or user interface that is reserved for presenting particular categories or types of information.

The term “memory control” refers to an operation performed by the processor to manage reading, writing, moving, or deleting data in memory or storage devices, including control of allocation and access to storage areas.

In one embodiment, a server, a terminal, and a user cooperate to implement the invention. The server includes at least one processor, a main memory, a nonvolatile storage device, a network interface, and, in some embodiments, one or more accelerator devices such as graphics processing units. The terminal includes a processor, a memory, a network interface, and a display device. The user interacts with the terminal through an input device such as a keyboard, a pointing device, or a touchscreen.

The server executes an operating system, such as a general-purpose server operating system, and application software including a web server program, an application framework, a mail server program, a database management system, an information browsing program, and a generative AI processing module. In one example, the server executes web server software functioning as an HTTP endpoint, an application server implemented in a high-level programming language, a mail server program conforming to a mail transfer protocol, a relational database management system, and an information browsing program that provides browser-like functionality. The terminal executes a client operating system and an electronic mail client program that is capable of receiving and displaying electronic mail messages and of communicating with the server by using a secure communication protocol.

The server stores in the nonvolatile storage device a program implementing the claimed processing and one or more trained generative AI models. The generative AI model is, in one embodiment, a neural network-based large language model having a transformer architecture. The model includes a plurality of attention layers, feed-forward layers, normalization layers, and embedding layers. The server stores model parameters as numerical weight values in a parameter file or database. The server also stores configuration parameters such as a maximum token length, a temperature parameter for sampling output tokens, and a top-k or top-p parameter to control diversity of generated outputs. The server stores classification rules and comparison thresholds in a configuration store accessible by the processor.

The terminal executes the mail client program to obtain electronic mail messages from the server or from another mail server over a network. The terminal stores raw message data including header fields and body content in a local storage area. The terminal parses the header fields to extract source identification information, such as an electronic mail address in a “From” header field, and parses the body content and relevant metadata as information related to the source identification information. The terminal normalizes the source identification information by converting alphabetic characters to a unified case, trimming leading and trailing whitespace, and isolating a domain part and a local part. The terminal stores this processed data in memory and transmits it to the server as part of a request message.

The server receives, via the network interface, a request from the terminal including the source identification information and the related information. The processor of the server parses the request data into structured internal objects, for example an object including separate fields for a sender address, a subject, a body excerpt, and a timestamp. The processor then generates a prompt sentence based on these fields. The processor selects a template from a set of stored templates in the nonvolatile storage device. Each template is designed to instruct the generative AI model to perform a specific information retrieval task.

In one example, the server generates the following prompt sentence in natural language: “Please determine whether the sender of this communication is legitimate or spoofed. The sender address is ‘support@paypa1.com’. The subject is ‘Your account has been limited’. The body is: ‘Your account has been limited. Please click the link below to verify your information: http://example.com’. If the sender appears to be spoofed, please identify the official communication address or domain that the genuine service actually uses.”

In another example, the server generates the following prompt sentence:
“Use a generative AI model to check if the source address ‘info@bank-secure. co’ is an official contact address of a financial institution. The message content is: ‘Unusual activity was detected. Confirm your account at this website.’ Provide the official domain or address used by the institution for customer notifications and explain whether the given address is likely spoofed.”

The processor constructs these prompt sentences by performing string formatting operations, concatenating fixed instruction phrases with variable parts derived from the received source identification information and the related information. The processor may redact sensitive elements, such as account numbers, by applying pattern detection based on regular expressions and replacing detected patterns with generic tokens. This pre-processing reduces exposure of confidential data while preserving semantic features needed by the generative AI model.

The server inputs the generated prompt sentence to the generative AI model. When the model is executed locally, the processor converts the prompt sentence into token IDs by applying a tokenizer associated with the model. The processor then performs forward propagation through the transformer network. In each transformer layer, the processor computes attention weights over token sequences using matrix multiplications and softmax functions, and it computes context-aware token representations. The processor then applies feed-forward layers and normalization, repeating this process across multiple layers. The output of the final layer is converted into output tokens representing a natural language response. When the server uses a remote AI service, the server transmits the prompt sentence through an application programming interface and receives the generated response as text data.

Within the generative AI processing module, the server controls model parameters to optimize the balance between determinism and diversity. For spoofing detection, the server configures the generative AI model with a relatively low temperature and constrained decoding parameters so that responses are stable and reproducible. The processor parses the model response by applying text analysis routines to extract candidate domain names and addresses. For example, the processor may search for patterns matching an electronic mail address format or for phrases indicating “official address” or “official domain.” The processor converts these extracted strings into normalized form by removing extraneous characters and converting alphabetic characters to a unified case.

The server further uses information browsing software to confirm or supplement the legitimate source identification information. The processor generates a search query string based on the model response and on the original source identification information. For example, the processor may construct a query such as:
“official customer support email for example payment service”

The server supplies this query string to the information browsing software. In one embodiment, the information browsing software is a headless browser program that the processor controls through an automation interface. The processor instructs the browser to navigate to a search engine page, input the query string into a search field, submit the query, and follow one or more search results that appear to be associated with official information sources, such as pages on a recognized top-level domain. The browser retrieves hypertext content, and the processor parses the content to extract links and text segments. The processor identifies candidate legitimate addresses, for example by scanning for patterns indicative of contact addresses.

The server aggregates the candidate legitimate source identification information obtained from the generative AI model and from the information browsing software into a data structure, such as a list of normalized address strings and a list of domains. The processor removes duplicate values and discards addresses that do not match predefined trust conditions, such as addresses on domains that do not match recognized official domains obtained from high-confidence sources. The server stores this aggregated candidate set in memory for use in comparison processing.

The server then compares the received source identification information from the terminal with the aggregated legitimate source identification information. The processor splits each electronic mail address into a local-part component and a domain-part component. For exact comparison, the processor applies an equality check on both components. For similarity-based comparison, the processor applies an algorithm, such as an edit distance algorithm, to compute a similarity score between the domain-part of the received address and each domain-part in the legitimate set. The server establishes threshold values for similarity during system configuration; for example, the server may treat two domains with an edit distance of 1 or 2 and with equal length as suspiciously similar.

The server may also compute additional features, such as the presence of numeral substitution for alphabetic characters or permutation of characters. The processor uses these features, combined with the similarity scores, to compute a spoofing likelihood value. The server stores this likelihood in memory and uses a rule-based evaluation process to derive an overall determination, such as “spoofed” or “not spoofed.” The rules may specify that a domain not present in the legitimate set but with a high similarity score to a legitimate domain is to be classified as spoofed. This combination of generative AI-derived knowledge, dynamic web-derived authoritative information, and algorithmic comparison yields improved detection accuracy compared with static rule sets.

When the server determines that spoofing is present, the processor generates notification information to send back to the terminal. The notification information includes at least the spoofing determination result, optional explanatory text indicating reasons for the decision, and references to legitimate source identification information when available. The notification information is encoded in a structured message and transmitted to the terminal via the network interface. The terminal receives the notification information and displays a warning to the user. The terminal may, for example, show the message:
“Warning: This message appears to be sent from a spoofed sender. The domain of the sender's address does not match the official domain. Official domain: ‘example.com’. Actual sender domain: ‘examp1e.com’.”

The server also performs classification of information associated with spoofing. The processor determines to which category the spoofed information belongs, for example unauthorized communication, advertising, or suspicious transaction. The processor refers to predefined classification criteria stored in configuration data. These criteria may include patterns in the subject or body text, the type of service being impersonated, and features computed from links or attachments. The processor then assigns a category label to the spoofed information and controls storage of the information. In some embodiments, the server instructs a mail server program to move spoofed messages to a designated storage area such as a spam folder or phishing folder. In other embodiments, the server modifies metadata associated with a data record in a database and causes a user interface to present spoofed items in a separate display region.

The described architecture improves computer technology in multiple ways. The server uses the generative AI model not merely as a language generator but as a component in a specific data processing pipeline. By encoding the problem into a prompt sentence and using transformer-based processing to infer likely legitimate identifiers and related context, the server reduces the need for manually curated lists and static rules. The integration with information browsing software allows the server to dynamically gather up-to-date information from public sources. This reduces latency in adapting to new spoofing methods and newly issued legitimate addresses. The comparison stage uses specialized string algorithms and feature extraction to compute similarity between identifiers in a manner specifically optimized for small, human-confusable variations. The combined pipeline thus reduces false negatives for near-spoofed domains and reduces false positives compared to simple pattern matching.

From a computational standpoint, the server improves processing efficiency by offloading intensive neural network inference to hardware accelerators and by using caching mechanisms. The processor may cache recently validated legitimate identifiers in memory or a fast-access storage system and reuse them when subsequent messages related to the same service are processed. This reduces the number of calls to the generative AI model and the frequency of web searches, thereby reducing computational load and communication traffic. The server may also schedule browser-based retrieval operations in a batch manner, grouping multiple similar queries and reusing retrieved pages when possible. These techniques collectively reduce network bandwidth usage and accelerate response time.

The generative AI model itself is trained in a manner that enhances its suitability for spoofing-related tasks. During training, the model is fine-tuned on datasets containing examples of legitimate and spoofed identifiers, along with explanations and associated official information. The server or an offline training system computes a loss function such as cross-entropy over target token sequences or over classification labels indicating correct identification of spoofed content. During training, the system adjusts weights in the transformer network by computing gradients of the loss function with respect to the weights and applying an optimization algorithm such as stochastic gradient descent with adaptive learning rates. Data augmentation techniques, such as introducing deliberately perturbed domains or addresses, are used to teach the model to recognize near-miss spoofing patterns that humans may overlook. This training process results in a model that is specifically adapted to the technical problem of recognizing spoofing patterns, rather than a generic language model.

The described system goes beyond simple automation of human review processes. A human reviewer might read a message, manually visit websites, and compare addresses visually, but such manual analysis is slow and error-prone, especially at large scale. The server performs operations that a human cannot feasibly perform at the same speed or scale, such as evaluating hundreds of candidate domains with numerical similarity measures in microseconds and cross-referencing them with dynamically obtained web information. Additionally, the use of AI-derived prompts and rules enables the server to detect subtle pattern regularities that humans might fail to codify as explicit rules. The pipeline, which tightly integrates the generative AI model, browsing software, comparison algorithms, and classification control, thus constitutes an improvement in the functioning of the computer system itself, particularly in terms of detection accuracy, processing throughput, and adaptability of data management.

In alternative embodiments, the server may employ different generative AI model architectures. For example, the server may use a sequence-to-sequence model with recurrent layers or a hybrid model combining convolutional elements and attention mechanisms. The server can use alternative similarity algorithms, such as cosine similarity in an embedding space derived from character-level or token-level encoders. The server can adopt different classification schemes for spoofed information, for example separating financial phishing, credential harvesting, malware distribution, and generic unsolicited messages into distinct categories. The terminal can implement different user interface presentations, such as color-coded indicators, separate tabs for different categories, or detailed explanation dialogs generated based on the notification information.

In another embodiment, the terminal may perform part of the processing, such as prompt sentence generation and initial extraction of candidate legitimate identifiers, and send intermediate results to the server. In still another embodiment, multiple servers may share a distributed database of legitimate identifiers and classification results to further improve efficiency and robustness. In each case, the core operations of generating a prompt sentence, orchestrating generative AI-based information retrieval, performing structured comparison of identifiers, determining spoofing, and controlling storage and display of classified information remain as described, thereby supporting the scope of the claims.

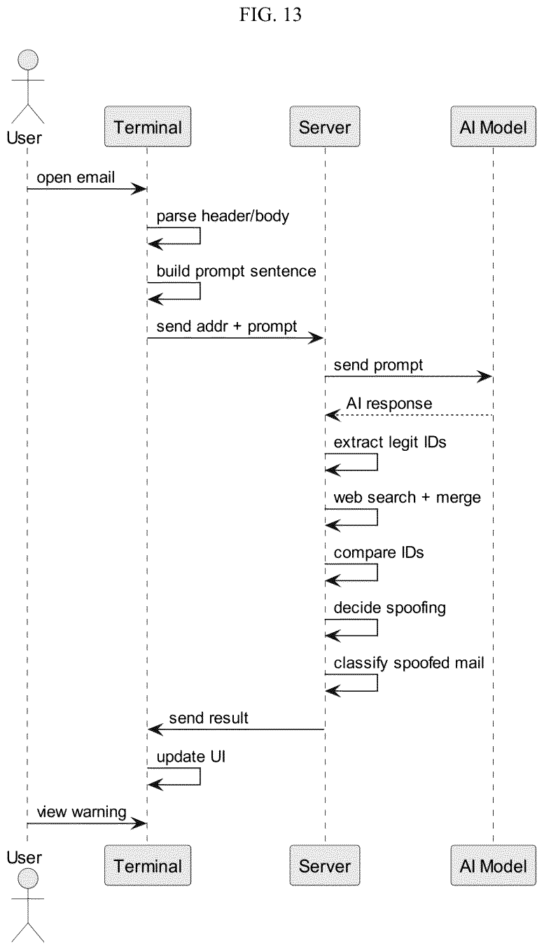

The following describes the processing flow using FIG. 13.

### Step 1:

The user operates the terminal to receive an electronic message. The input is a message delivered from a communication network, including header fields and body content. The terminal, executing a mail client program, stores the raw message data in local memory or storage. The terminal writes the header section and the body section as separate data structures so that subsequent processing can access them independently. The output is stored raw message data associated with a message identifier.

### Step 2:

The terminal parses the stored raw message data to extract source identification information and related information. The input is the raw header data and body data of the message. The terminal executes a parsing routine that reads the “From” header field and other optional fields such as “Reply-To” and “Return-Path,” and then normalizes the extracted address by trimming whitespace and converting characters to lowercase. The terminal extracts the body text by decoding MIME parts and, when necessary, converting HTML to plain text. The output is a structured record that includes at least a normalized source address, a subject string, and a body text segment.

### Step 3:

The terminal generates a prompt sentence for a generative AI model based on the structured record. The input is the normalized source address and the related information, including the subject and a body excerpt. The terminal selects a template from stored templates and performs string concatenation and placeholder substitution to embed the specific address and content into the template. The terminal may remove or mask personal identifiers using regular expression matching before insertion. The output is a prompt sentence expressed in natural language, such as: “Please determine whether the sender of this communication is legitimate or spoofed. The sender address is ‘support@paypa1.com’. The subject is ‘Your account has been limited’. The body is: ‘Your account has been limited. Please click the link below to verify your information: http://example.com’.”

### Step 4:

The terminal transmits the prompt sentence and the original source identification information to the server. The input is the prompt sentence string and the normalized source address stored in the structured record. The terminal constructs a request message formatted according to a network protocol, for example an HTTP request, and embeds the prompt sentence and address into fields of a request body. The terminal sends this request over a secure communication channel through its network interface. The output is a network packet sequence that arrives at the server.

### Step 5:

The server receives the request and parses the input data. The input is the request message containing the prompt sentence and the normalized source address. The server, executing an application program, decodes the message, validates its structure, and converts the received text into internal variables within a memory-resident object. The server checks authentication or integrity tokens if present. The output is an internal representation containing a prompt sentence string and a normalized source identification string accessible to subsequent modules.

### Step 6:

The server invokes the generative AI model using the prompt sentence. The input is the prompt sentence string from the internal representation. The server applies a tokenizer associated with the model to convert the prompt into a sequence of token identifiers, and then performs forward propagation through the layers of the model. The server computes attention weights, intermediate embeddings, and output logits, and finally decodes the logits into output tokens which are concatenated into a response text. Alternatively, when the model is remote, the server transmits the prompt through an API and receives the response text. The output is a natural-language response produced by the generative AI model, stored as a text string.

### Step 7:

The server analyzes the generative AI response to extract candidate legitimate source identification information. The input is the response text from the generative AI model. The server executes a pattern extraction routine that scans the response for sequences that match address patterns and domain patterns, such as strings containing an “@” symbol and valid domain suffixes. The server normalizes these strings by trimming surrounding punctuation and converting letters to lowercase. The output is a candidate list including one or more legitimate source addresses or domains identified by the generative AI model.

### Step 8:

The server generates a search query for information browsing software based on the generative AI response and the original source address. The input is the candidate list and the original normalized source identification information. The server constructs a query string by combining the name of a service inferred from the response with key terms indicating official contact or support, and optionally includes the domain portion of the source address. The server produces a compact query that is likely to return official contact information when used by a search engine. The output is a search query string suitable for input into information browsing software.

### Step 9:

The server controls information browsing software to retrieve candidate information from public information sources. The input is the search query string and control commands issued by the server. The server instructs a browser-like program to open a search service page, input the query string into a search form, and submit the query. The browsing software downloads search result pages over the network, and the server parses the resulting documents to identify links and text blocks associated with official domains. The server follows selected links, retrieves target pages, and scans their content to detect contact addresses or domains mentioned as official. The output is another candidate set of legitimate addresses and domains extracted from accessible public information sources.

### Step 10:

The server aggregates and normalizes all candidate legitimate source identification information. The input is the candidate list from the generative AI response and the candidate set from browsing. The server merges these lists into a unified data structure, removes duplicates by comparing normalized forms, and discards entries that do not satisfy minimal validity rules, such as unsupported domain formats. The server may also annotate each entry with a confidence score derived from the source type, for example assigning higher weight to entries sourced from official-looking domains. The output is an aggregated legitimate information set consisting of normalized addresses and domains with associated metadata.

### Step 11:

The server compares the received source identification information with the aggregated legitimate information set. The input is the normalized source address originally sent by the terminal and the aggregated legitimate information set. The server splits the source address into a local part and a domain part and performs exact string comparison with entries in the legitimate set. The server additionally applies an edit-distance algorithm to the domain part and to legitimate domains to compute similarity scores. When necessary, the server also computes feature values such as the presence of numeric substitution for alphabetic characters. The output is a comparison result including boolean indicators for exact matches, numerical similarity scores, and feature flags indicating suspicious patterns.

### Step 12:

The server determines whether spoofing is present based on the comparison result and predefined thresholds. The input is the comparison result and configuration parameters such as similarity thresholds and rule conditions. The server applies a decision function that evaluates combinations of conditions, such as “no exact domain match,” “similarity above a threshold,” and “feature flag for character substitution.” The server may compute a composite score and compare it to a decision threshold. The output is a spoofing determination result, such as a binary spoofing flag and, optionally, a numeric likelihood value.

### Step 13:

The server generates notification information describing the spoofing determination and legitimate identifiers. The input is the spoofing determination result, the aggregated legitimate information set, and the original source address. The server constructs a structured notification message that includes a status indicator (spoofed or not spoofed), a human-readable explanation string, and any legitimate addresses or domains that were identified. The server formats this message for transmission to the terminal. The output is a notification payload ready to be sent over the network.

### Step 14:

The server transmits the notification payload to the terminal. The input is the notification payload generated in the previous step. The server encapsulates this payload in a response message using a network protocol, sets appropriate headers, and uses the network interface to send the response to the terminal. The output is a response transmitted across the communication path and received by the terminal.

### Step 15:

The terminal receives the notification payload and updates the display for the user. The input is the response message containing the spoofing determination and related data. The terminal decodes the message and passes the spoofing status, explanation, and legitimate identifier information to the mail client program. The mail client alters its internal record for the message to include a spoofing flag and then renders a visual indicator on the display, such as a warning banner or icon. The output is an updated user interface state in which the message is visually distinguished according to the spoofing determination.

### Step 16:

The server classifies information associated with spoofing into predefined categories. The input is the spoofing determination result and the content and metadata of the message. The server applies classification rules that map patterns in the subject, body, and links, along with identifier characteristics, to categories such as unauthorized communication, advertising, or suspicious transaction. The server computes rule-based scores for each category and selects at least one category with the highest score. The output is a classification result that associates the spoofed information with one or more category labels.

### Step 17:

The server controls the storage location and display format of the spoofed information based on the classification result. The input is the classification result and references to the stored message in the mail storage or database. The server issues commands to a mail server or storage subsystem to move the message to a category-specific folder, such as a phishing folder or unsolicited advertising folder. The server also updates metadata that specifies recommended display attributes, for example showing certain categories with more prominent warnings. The output is a changed storage state in which the message resides in a category-appropriate storage area and is associated with display control metadata.

### Step 18:

The user interacts with the terminal to review or ignore the classified information. The input is the updated user interface presented by the terminal, including locations and display formats defined by the server's control operations. The user may open the folder corresponding to spoofed or suspicious messages, inspect explanatory messages, or choose to delete or archive the items. The system does not alter the spoofing determination based on this interaction, but the interaction closes the loop by enabling human oversight when necessary. The output is a user decision regarding the further handling of the message, which may be recorded by the terminal or server for logging and future model tuning.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional electronic communication systems, such as mail processing systems and messaging platforms, rely primarily on static rule-based filters, simple string matching, and pre-defined blacklists or whitelists to determine whether incoming information is spoofed or illegitimate. These systems typically compare a sender identifier with a stored list of known legitimate identifiers, or apply fixed pattern-matching rules to header fields and content. As network environments and attack techniques evolve, such static mechanisms become increasingly ineffective, leading to significant technical problems: high false negative rates, in which sophisticated spoofed messages are not detected, and high false positive rates, in which legitimate messages are erroneously blocked. Both kinds of errors degrade the reliability and utility of the underlying computer system itself.

Furthermore, conventional systems are generally unable to leverage large-scale external information resources and advanced probabilistic reasoning to infer a “normal” or official source identifier in real time. Even when external data is accessed, the system often treats that data as a simple list of strings without structured reasoning. As a result, the system cannot adaptively determine whether a sender identifier is consistent with the behavior and public-facing identifiers of a given organization. This limitation constrains the scalability and precision of spoofing detection and forces system designers to continuously hand-tune rules, which does not scale well as the volume and diversity of communications increase.

In addition, existing systems do not effectively incorporate user-specific context such as the user's emotional state into the core decision process of the computer system. User interfaces may display warnings or notices, but the underlying decision thresholds and filtering strength of the system itself typically remain static. Consequently, even when a user is in a particularly vulnerable state (for example, anxious or confused), the system fails to adjust its detection sensitivity, thereby exposing the user to elevated risk. Conversely, when the user is calm and able to review messages carefully, the system still applies the same strict thresholds, which can cause unnecessary blocking of legitimate messages and reduce user trust in the system's output.

Moreover, known architectures often treat spoofing detection, external information retrieval, and user state analysis as disjoint modules, without a unified control logic inside the processor that coordinates these functions. This fragmented design leads to redundant data processing, inconsistent criteria across modules, and increased latency, as separate subsystems independently fetch and analyze similar information. The absence of an integrated control mechanism that orchestrates prompt generation, generative model interaction, spoofing judgment, and adaptive filtering prevents the computer system from achieving an optimized trade-off between security and usability at the system level.

Accordingly, there is a need for an improved computer-implemented system that: (i) automatically generates and uses prompt sentences to control a generative AI model for retrieving and inferring normal source identification information from network-based resources; (ii) performs structured comparison between this inferred normal identification information and input identification information using flexible matching criteria; (iii) dynamically adjusts such criteria in response to user emotion-related information; and (iv) integrates these operations in a unified processor-controlled workflow. Such a system should technically improve the way the computer processes, classifies, and stores communication data, by reducing misclassification, adapting filtering strength to contextual conditions, and efficiently coordinating the use of external information and emotion recognition within the core processing path.

The specific processing by the specific processing unit 290 of the data processing device 12 in Application Example 2 is realized by the following means.

The present invention provides a server comprising a processor and a storage device, the processor being configured to receive information including identification information and content information as input from an external apparatus; to generate, based on the identification information and the content information, a prompt sentence for instructing a generative AI model to perform information retrieval; to input the generated prompt sentence to the generative AI model; to obtain, from information sources including network-based information resources, a candidate of normal source identification information by analyzing a response result from the generative AI model and information obtained from the information sources; to compare the candidate of the normal source identification information with the identification information received as the input based on at least one of a string matching degree, a domain structure, a similarity index, and a preset matching criterion; to determine, based on a comparison result, whether or not the input information is spoofed and to generate a spoofing determination result; to analyze emotion-related information associated with the input information to specify an emotional state of a user; to dynamically adjust at least one of the matching criterion and a determination threshold according to the emotional state, thereby changing filtering strength of the spoofing determination; to automatically classify the input information into at least one of a safe-information category, a suspicious-information category, and an exclusion-information category based on the spoofing determination result and the filtering strength; to notify an external apparatus of a classification result and automatically move information classified into the exclusion-information category to an isolation area; and to record, in the storage device, history information including at least the spoofing determination result, the candidate of the normal source identification information, the emotional state, and the filtering strength in a form usable for subsequent determination processing and criterion updating processing. This enables the computer system to technically improve spoofing detection and information filtering by coordinating generative AI-based retrieval with adaptive matching criteria, by dynamically tuning filtering strength according to user emotion-related context, and by integrating these functions into a unified, processor-controlled workflow that reduces misclassification, enhances security, and optimizes resource usage in electronic communication environments.

The term “system” refers to an arrangement including at least one hardware device and at least one software component that cooperatively execute processing to achieve spoofing determination and information classification.

The term “processor” refers to a hardware computation element, such as a central processing unit or an execution core, that executes instructions to perform the functions of receiving information, generating prompt sentences, interacting with a generative AI model, performing comparisons, making determinations, and controlling classification and storage.

The term “storage device” refers to a hardware memory component, such as a volatile memory or a non-volatile memory, that stores data including input information, prompt sentences, determination results, emotional state information, filtering strength information, and history information.

The term “information” refers to digital data including at least identification information and content information associated with an electronic communication, such as a message, a mail item, or other electronic content subject to spoofing determination.

The term “identification information” refers to data used to identify a source or sender of the information, such as a communication address, an account identifier, or a domain indicator used in electronic communication.

The term “content information” refers to data representing the body or substantive part of the information, such as text, structured fields, or other message content that is not solely the identification information.

The term “prompt sentence” refers to text data that expresses a request or instruction to a generative AI model in natural language and that specifies an information retrieval or inference task to be performed by the generative AI model.

The term “generative AI model” refers to a machine learning model configured to generate or transform information, including natural language text, in response to an input prompt sentence, and to perform tasks such as information retrieval, inference, and response generation using learned parameters.

The term “information retrieval” refers to processing in which the generative AI model and/or the processor accesses and obtains data from one or more information sources, including network-based resources, based on a prompt sentence or equivalent query.

The term “network-based information resources” refers to data repositories accessible via a communication network, such as remote servers, databases, or websites, that store information relevant to determining normal source identification information.

The term “normal source identification information” refers to identification data that is considered to represent an official, legitimate, or expected source of the information, such as an official communication address or officially recognized identifier associated with an organization or service.

The term “candidate of normal source identification information” refers to a possible instance of normal source identification information that has been inferred or extracted from responses of the generative AI model and/or from network-based information resources.

The term “string matching degree” refers to a measure indicating how closely two character sequences, such as two identification strings, correspond to each other, which may be computed by exact matching, partial matching, or a similarity metric.

The term “domain structure” refers to the hierarchical composition of a domain identifier, such as elements separated by delimiters in a network address, and relationships among those elements used to compare domains for spoofing determination.

The term “similarity index” refers to a numerical or categorical value representing a degree of resemblance between two data elements, such as two identification strings or domains, calculated by a similarity algorithm.

The term “matching criterion” refers to a rule or threshold condition specifying how to interpret the string matching degree, domain structure relationship, or similarity index when deciding whether identification information corresponds to normal source identification information.

The term “determination threshold” refers to a quantitative or qualitative boundary value used by the processor to convert a continuous or multi-level measure, such as a similarity index or confidence score, into a discrete decision outcome such as spoofed or not spoofed.

The term “spoofing” refers to a condition in which the identification information of received information falsely represents or imitates a normal source identification information, thereby misleading a system or user about the true origin of the information.

The term “spoofing determination result” refers to data indicating the outcome of a spoofing assessment, including whether the information is judged to be spoofed, not spoofed, or suspicious, and optionally a risk level or reason code.

The term “emotion-related information” refers to data from which an emotional state of a user can be inferred, including, but not limited to, user-entered text, voice signals, or image signals reflecting facial expressions or other behavioral cues.

The term “emotional state” refers to a representation of a psychological condition of a user, such as anxiety, anger, calmness, or confusion, that is estimated from emotion-related information by emotion recognition processing.

The term “emotion recognition processing” refers to computational analysis applied to emotion-related information to estimate the emotional state of a user, using techniques such as natural language processing, audio analysis, or image analysis.

The term “filtering strength” refers to a level or degree of strictness applied by the processor when classifying information as safe, suspicious, or exclusion-target, which is influenced by the matching criterion, determination threshold, and emotional state.

The term “safe-information category” refers to a classification label assigned to information that is judged to be legitimate or sufficiently low risk according to the spoofing determination result and the filtering strength.

The term “suspicious-information category” refers to a classification label assigned to information that is not clearly safe or spoofed, and that may require additional caution or review by the system or user.

The term “exclusion-information category” refers to a classification label assigned to information that is judged to be spoofed or highly risky and is therefore subject to isolation or removal from normal processing paths.

The term “classification result” refers to data indicating the category assigned to the information, such as the safe-information category, suspicious-information category, or exclusion-information category, and optionally associated metadata.

The term “external apparatus” refers to a device outside the server, such as a user terminal or client system, that sends information to the server and receives notifications or classification results from the server.

The term “isolation area” refers to a logical or physical storage region in which exclusion-target information is stored separately from normal information, such that it is not processed or displayed in the same manner as safe information.

The term “history information” refers to stored records including, for each piece of processed information, at least the spoofing determination result, the candidate of the normal source identification information, the emotional state, and the filtering strength at the time of the determination.

The term “subsequent determination processing” refers to later processing operations that use the history information to perform additional spoofing determinations, refinements, or validations on new or previously processed information.

The term “criterion updating processing” refers to processing in which the system modifies at least one matching criterion, determination threshold, or related parameter, based on history information, to improve future spoofing determination and classification accuracy.

In one embodiment, a server, a terminal, and a user cooperate to implement the claimed system. The server includes at least one processor, a main memory, a non-volatile storage device, and a network interface. The terminal includes a user interface unit, a local memory, and a communication interface. The user operates the terminal to submit information for spoofing determination and to receive classification results.

The server executes an operating system and an application program that implements the spoofing determination logic. The server program is stored in the storage device and loaded into the main memory for execution by the processor. The server program is implemented, for example, using a general-purpose programming language and uses software libraries including a natural language processing library (such as a tokenization and parsing library), an HTTP client library, a network communication framework, and a database access driver. The server program further communicates with a remote generative AI model provided by a computation service, and may use a deep learning framework (such as a tensor computation library) when a local generative AI model or a local emotion recognition model is deployed.

The terminal executes a client application that may be integrated into a message processing application or provided as a standalone application. The terminal application provides a graphical user interface that displays received electronic messages and allows the user to select a message and trigger verification. The terminal application formats identification information (for example, a sender address or account identifier), content information (for example, a message body or header fields), and optional emotion-related information (for example, user-entered comments) into a predetermined data structure, and transmits this data to the server over a network using a secure protocol.

The server receives the data and stores it in a structured form in the main memory. The server uses explicit data structures, such as key-value maps and record objects, to hold fields including sender identifier, domain part, local part, message text, timestamps, and user context flags. The server uses a natural language processing library (for example, a library for tokenization, sentence segmentation, and normalization) to preprocess the content information and to normalize identifiers. This preprocessing includes converting characters to a canonical form, splitting domain identifiers into components, and removing markup or tracking codes from the content information. By performing this preprocessing on the server, the system reduces redundancy and prepares data for efficient subsequent comparisons, which improves processing speed and reduces memory fragmentation.

The server generates a prompt sentence for a generative AI model based on the collected identification information and content information. The server program uses a template-based construction in which placeholders in a base sentence are filled with normalized domain names, message summaries, and context flags. The prompt sentence is represented as a contiguous character sequence in memory and may be concatenated from multiple segments to avoid repeated string allocations. Examples of such prompt sentences include the following:
“Please check whether the sender address info@example.com is an official address for the organization associated with the domain example.com. Search public network resources and return the list of official contact or support email addresses.”
“For the following message text and sender identifier, infer the legitimate organization and list all official communication addresses. Message text: [message body]. Sender identifier: info@phishing.com.”
“Verify whether support@secure-payments. example.com is a legitimate email address for the organization that owns example.com. Identify official domains and subdomains and distinguish suspicious look-alike domains.”

By generating these prompt sentences automatically from structured data, the server can systematically control the type of reasoning requested from the generative AI model and can limit the search scope, which reduces network usage and response variability.

The server communicates with a generative AI model through a network interface. In one embodiment, the generative AI model is a transformer-based neural network that has multiple attention layers, feed-forward layers, and layer normalization components. The generative AI model uses learned parameters (weight matrices and bias vectors) to transform an input sequence of tokens derived from the prompt sentence into an internal representation and then into an output token sequence. The generative AI model can be a large language model having several billion parameters, trained on a corpus of text including network-visible documents, documentation, and structured records.

During training of such a generative AI model, a supervised learning method is used. The model parameters are initialized and iteratively updated based on a loss function, such as a cross-entropy loss between predicted tokens and target tokens. An optimization algorithm, such as stochastic gradient descent with adaptive learning rates, updates the parameters using gradients computed by backpropagation. Data augmentation techniques, such as random masking, random sampling of input segments, and domain-specific fine-tuning using labeled examples of legitimate and spoofed identifiers, can be used to improve generalization and robustness. While the generative AI model may be trained prior to deployment, describing this training pipeline clarifies that the model is a technical artifact whose internal parameters embody classification and inference capabilities that differ from simple rule-based lookups or manual human reasoning.

When the server sends a prompt sentence to the generative AI model, the model converts the characters to tokens using a tokenizer, feeds the tokens into the neural network layers, and produces an output token sequence. The server then decodes this output into text. The server does not treat this text as an opaque response; instead, the server parses it using deterministic parsing rules and, in some embodiments, incremental parsing algorithms. The server searches for patterns that indicate candidate normal source identification information, such as patterns matching communication addresses, domain names, or explicit statements like “official contact,” “support address,” or “primary email.” The server also optionally queries network-based information resources directly using an HTTP client, fetching content from network locations associated with the domain (for example, contact pages, policy pages, or directory listings) and analyzing those pages with an HTML parsing library. The combination of generative AI output and direct resource retrieval allows the server to construct a candidate set of normal source identification information that is richer than a static list.

The server stores each candidate identifier as an element of a structured collection, such as an array or set, where each element includes fields for the full identifier string, its domain, its source (generative AI output or network document), and any confidence score. The server then compares the user-provided identification information with each candidate in this collection. The server program implements specialized comparison algorithms that go beyond simple string equality. For example, the server can compute a similarity index by applying a character-level distance function (such as an edit distance) and a domain structure comparison that splits identifiers into subcomponents (for example, local part, second-level domain, top-level domain) and assigns weights to differences in each level. The server may also normalize internationalized domain names and apply homograph detection logic to reduce false negatives arising from visually similar but distinct characters.

These comparison algorithms are implemented by the processor as sequences of arithmetic operations, logical operations, and memory access operations. The server keeps intermediate comparison results in fixed-size structures to support vectorized processing and caching. By structuring comparison in this manner, the server reduces the number of memory allocations and branch mispredictions during execution, which improves throughput when many messages must be processed quickly.

The server further obtains emotion-related information and uses a separate emotion recognition module. In one embodiment, the server receives text comments from the terminal, such as “I am very worried about this email.” The server applies a text-based emotion classifier implemented as a neural network model (for example, a bidirectional recurrent network or a transformer encoder) trained on labeled emotional text data. The classifier uses an embedding layer to convert tokens into vectors, passes them through multiple layers with nonlinear activation functions, and outputs a probability distribution over emotion categories such as calm, anxious, and angry. The training of this classifier can use a loss function such as cross-entropy and regularization techniques such as dropout or weight decay. In another embodiment, the terminal performs local emotion recognition using sensors (for example, a camera or microphone), and sends only summarized emotional state information to the server. In that case, the server uses the received emotional state as a context parameter.

The server maps the emotional state to filtering strength settings. For example, when the user is estimated to be anxious, the server raises the determination threshold for accepting an identifier as legitimate, or lowers the tolerance for domain differences. When the user is calm, the server lowers the thresholds to reduce false positives. This mapping is not a simple scaling of a single value; the server may adjust multiple parameters in the comparison algorithms, such as different weights for domain-level and local-part-level differences. The server maintains these parameters for each user or for each session in a context table stored in the main memory. By adjusting parameters in this structured context table, the server can update filtering behavior quickly without recomputing base data or reinitializing the comparison modules.

The server uses the spoofing determination result and the current filtering strength to assign the incoming information to a classification category. The server maintains explicit enumerations for categories: safe-information, suspicious-information, and exclusion-information. When the server determines that the identifier matches a normal source identification information candidate within the adjusted thresholds, the server assigns the safe category. When the difference is significant but not conclusive, the server assigns the suspicious category. When the difference exceeds strict thresholds or when the domain is associated with known attack patterns, the server assigns the exclusion category. The server writes this classification to a relational database or a key-value store together with metadata including timestamps, user identifiers, and emotion-state markers. The server then instructs the terminal to move messages assigned to the exclusion category into a designated isolation area, such as a special message folder that is not included in standard message synchronization. This instruction is transmitted using a structured message over the network, and the terminal modifies its local message storage accordingly.

The server also records history information in the storage device. The history data structure includes, for each processed message, fields representing the spoofing determination result, the candidate normal source identification information, the emotional state, the filtering strength, and any intermediate similarity scores. The server can later process this history to update matching criteria. For instance, if historical data indicates that certain comparison configurations lead to many later corrections by the user (e.g., user manually rescuing messages from the isolation area), the server can reduce the strictness of those configurations. This update may be performed periodically by a background process that computes statistics over stored records and adjusts matching thresholds according to a rule-based or optimization-based procedure. In this way, the system improves its performance over time by exploiting historical evidence in a structured, algorithmic manner, which goes beyond static human-defined rules.

By implementing the above structure, the server improves computer technology itself in multiple ways. First, the use of generative AI model outputs as a structured input to a specialized comparison engine, rather than as a direct final decision, reduces reliance on static lists and allows the server to infer new patterns of legitimate identifiers, enhancing detection accuracy and adaptability. Second, the prompt sentence structure allows the server to control the scope and nature of information retrieval tasks, thereby reducing unnecessary network operations and ensuring that the generative AI model returns data in a format that is easier to parse and compare, which improves computational efficiency. Third, the dynamic adjustment of filtering strength based on emotional state modifies internal parameters at runtime in a systematic way that reduces false negatives in high-risk contexts and reduces false positives in low-risk contexts, leading to better utilization of processing resources and storage capacity. Fourth, the explicit data structures and algorithms used for comparison and history-based criterion updates are designed to minimize memory copies, reduce branch divergence, and facilitate caching, thus improving throughput and latency for large-scale message processing.

The terminal, by executing instructions from the server and applying local storage and display operations, contributes to technical effects as well. The terminal removes exclusion-category information from normal display and reduces the volume of data synchronized to primary user views, which decreases the processing load in the graphical subsystem and network stack. The terminal also ensures that classification results are clearly presented, which enables the user to quickly recognize high-risk messages without manually scanning all identifiers. By offloading complex generative AI and comparison logic to the server, the terminal can operate on less powerful hardware while still providing a robust spoofing detection experience.

In another embodiment, the server may deploy the generative AI model locally instead of relying on an external computation service. In such a case, the server stores the model parameters in the storage device and loads them into the main memory as needed. The processor then executes a tensor computation library to perform matrix multiplications and nonlinear transformations associated with transformer layers. This local deployment reduces communication latency and avoids dependence on external services, and allows further customization of the model using domain-specific training data. In yet another embodiment, the server can use different neural network architectures for emotion recognition, such as convolutional networks for image-based emotion detection or spectral convolution networks for audio-based emotion detection, depending on the type of emotion-related information available.

In a further embodiment, the server can adjust prompt sentence templates and parsing logic to support different identification information types, such as device identifiers, account names, or uniform resource locators. The same generative AI and dynamic filtering framework can be applied, with comparison algorithms modified to treat additional components such as path segments or query parameters. This variation demonstrates that the technical improvements achieved by the claimed system, including more accurate identification of legitimate sources, adaptive filtering, and efficient data management, are not limited to a specific communication protocol but can generalize to various digital identification scenarios.

Through these configurations and variations, the server, the terminal, and the user together realize a system in which the generative AI model, the prompt sentence construction, the comparison algorithms, and the emotion-aware filtering are integrated into a concrete hardware and software architecture. This integration produces technical effects in terms of improved detection precision, reduced processing overhead, enhanced data management, and adaptive resource usage, distinguishing the invention from mere automation of a human mental process or business rule execution.

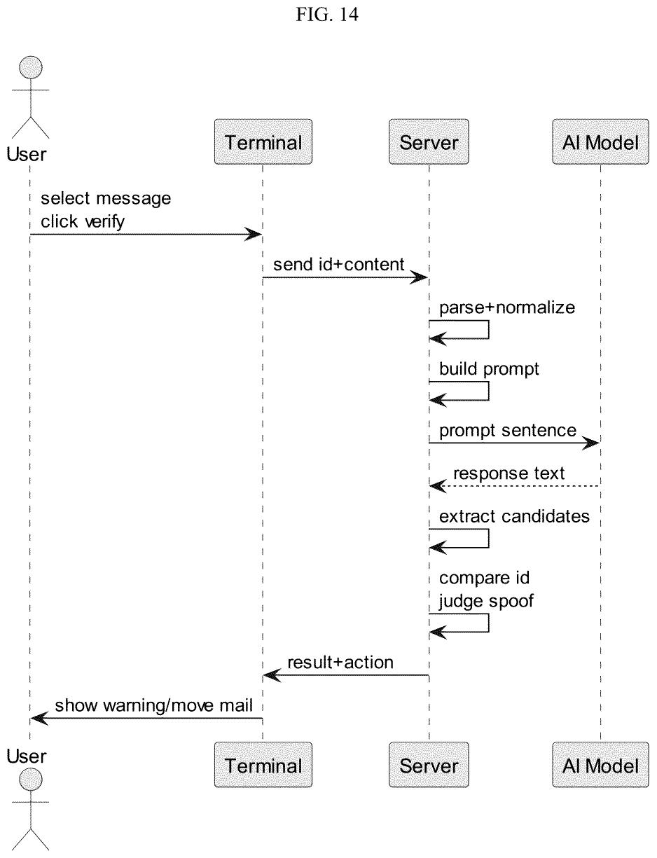

The following describes the processing flow using FIG. 14.

### Step 1:

User operates the terminal to submit information for verification.

User selects a message on the terminal and triggers a verification command (for example, by pressing a “Verify sender” button). The input of this step is the message displayed on the terminal, including at least a sender identifier (such as an email address) and content information (such as a message body). The terminal extracts the sender identifier, the content information, and optional user comments (for example, “I am worried about this email”), and formats them into a structured internal record. The output of this step is a structured request containing the sender identifier, the content information, and the optional user comment, transmitted from the terminal to the server over a network.

### Step 2:

Server receives the structured request and performs initial parsing and normalization.

Server accepts the incoming request via a communication interface and decodes the structured data into memory objects. The input of this step is the structured request sent from the terminal. The server splits the sender identifier into a local part and a domain part, converts characters to a canonical case, and removes invalid symbols. The server also cleans the content information by removing markup and converting text to a normalized encoding. The output of this step is a normalized data set containing a canonical sender identifier, a separated domain, and a cleaned content string, stored in server memory.

### Step 3:

Server summarizes the content information and prepares data for prompt sentence generation.

Server uses a natural language processing routine to segment the cleaned content into sentences, remove redundant portions (such as long signatures), and optionally generate a brief summary of the content. The input of this step is the normalized content string and the canonical sender identifier from Step 2. The server counts token frequencies, identifies key terms, and truncates the text to a manageable length for the generative AI model. The output of this step is a compact representation of the message, including a summarized content string and key domain-related terms, which are stored as fields for use in prompt sentence construction.

### Step 4:

Server generates a prompt sentence for the generative AI model based on the normalized data.

Server constructs a prompt sentence by embedding the canonical sender identifier, the domain part, and the summarized content into a predefined natural-language template. The input of this step is the canonical sender identifier, the domain part, and the summarized content from Step 3. The server concatenates template segments and variable fields to form a coherent instruction, such as: “Please check whether the sender address info@example.com is an official address for the organization associated with the domain example.com. Search public network resources and return the list of official contact or support email addresses.” The output of this step is a complete prompt sentence string stored in server memory and ready to be sent to the generative AI model.

### Step 5:

Server sends the prompt sentence to the generative AI model and receives a response.

Server passes the prompt sentence to a generative AI model via an application programming interface. The input of this step is the prompt sentence string from Step 4. The generative AI model converts the prompt into tokens, processes them through multiple neural network layers, and produces an output sequence of tokens that is decoded into a response text. The server receives this response text, which may describe official contact addresses or indicate that no official addresses are found. The output of this step is the response text from the generative AI model, stored by the server as an intermediate textual result.

### Step 6:

Server optionally retrieves additional information from network-based resources.

Server performs direct retrieval of information from network resources associated with the domain part of the sender identifier. The input of this step is the domain part and any URLs or organization names inferred from the prompt and the response text. The server forms network requests to likely official sites (for example, main pages or contact pages) and downloads their content. The server then parses these documents to detect patterns corresponding to identification information, such as addresses embedded in “mailto:” links or contact sections. The output of this step is a collection of candidate official identifiers extracted from network resources, held in a structured list together with the source of each candidate.

### Step 7:

Server extracts candidate normal source identification information from the AI response and merged resources.

Server analyzes the response text from the generative AI model using pattern-matching and parsing rules to detect identifiers and domain references. The input of this step is the AI response text from Step 5 and the candidate identifiers from network-based resources from Step 6. The server searches for substrings matching known identifier formats and records them along with any qualifiers such as “official” or “primary.” The server then merges the identifiers found in the AI response and those extracted from network resources into a unified candidate set, removing duplicates and annotating each candidate with confidence attributes. The output of this step is a structured candidate set of normal source identification information stored in server memory.

### Step 8:

Server computes similarity metrics between the input identifier and each candidate.

Server compares the canonical sender identifier received from the user with each candidate identifier in the candidate set. The input of this step is the canonical sender identifier from Step 2 and the candidate set from Step 7. The server calculates one or more similarity metrics, such as string distance values, domain structure matches, and character-level similarity scores. The server also flags visually similar but technically different domain names using homograph detection rules. The output of this step is, for each candidate, a set of numeric similarity values and match flags stored in association with the candidate in memory.

### Step 9:

Server applies matching criteria and determination thresholds to judge spoofing.

Server evaluates the similarity metrics against preset matching criteria and adjustable thresholds to determine whether the sender identifier corresponds to a normal source. The input of this step is the numeric similarity values and match flags from Step 8, together with baseline matching criteria from server configuration. The server checks conditions such as exact domain match, minimal allowed edit distance, and allowed subdomain patterns. Based on these checks, the server classifies the identifier as legitimate, suspicious, or spoofed. The output of this step is a preliminary spoofing determination result that includes a decision label and an associated risk level.

### Step 10:

Server processes emotion-related information to estimate the user's emotional state.

Server determines the emotional state of the user using available emotion-related input. The input of this step is either user-entered comment text from the terminal or summarized emotion parameters sent by the terminal. When text is provided, the server applies an emotion recognition model to the text, transforming tokens into embeddings and computing probabilities for emotion categories. When emotion parameters are provided directly, the server reads an already computed emotional state. The output of this step is a discrete emotional state label (such as calm, anxious, or angry) and an associated confidence score stored in server memory.

### Step 11:

Server adjusts filtering strength and matching thresholds based on the emotional state.

Server modifies internal configuration parameters controlling spoofing sensitivity according to the emotional state. The input of this step is the emotional state and confidence score from Step 10 and the baseline thresholds used in Step 9. The server selects a filtering profile (for example, normal or strict) and computes new values for matching thresholds, weighting factors for domain differences, and decision boundaries for assigning risk levels. The output of this step is an updated set of filtering parameters that override or adjust the baseline criteria for the current verification session.

### Step 12:

Server refines the spoofing determination using the adjusted filtering parameters.

Server re-evaluates the preliminary spoofing decision with the updated filtering parameters. The input of this step is the preliminary spoofing determination result from Step 9, the similarity metrics from Step 8, and the updated filtering parameters from Step 11. The server re-applies decision rules using the stricter or more relaxed thresholds, which can change borderline cases into confirmed spoofed or confirmed legitimate categories. The output of this step is a final spoofing determination result, including a decision label, risk level, and explanation of the decision basis.

### Step 13:

Server assigns a classification category to the information based on the final determination.

Server maps the final spoofing determination result to a classification category. The input of this step is the final spoofing determination result from Step 12. The server assigns the information to one of a safe-information category, a suspicious-information category, or an exclusion-information category according to the decision label and risk level. The server encapsulates this classification into a classification record that includes identifiers, timestamps, and emotional context. The output of this step is the classification record stored in server memory and prepared for storage and notification.

### Step 14:

Server stores history information in persistent storage for later use.

Server writes the classification record, together with intermediate data, to a storage device. The input of this step is the classification record from Step 13 and associated data such as the candidate set, similarity values, emotional state, and filtering parameters. The server organizes the data into tables or indexed collections and performs write operations to the storage device, ensuring that the data can be retrieved efficiently for future analysis. The output of this step is a persistent history entry that can support later criterion updates and performance evaluations.

### Step 15:

Server notifies the terminal of the classification result and recommended handling.

Server composes a response message containing the final spoofing determination result, the assigned classification category, and any recommended actions. The input of this step is the classification record from Step 13. The server formats this information into a structured response suitable for transmission over the network and includes optional explanatory text, such as “This message is likely spoofed and has been placed in an isolation area.” The output of this step is a notification message sent to the terminal over the communication interface.

### Step 16:

Terminal receives the notification and updates local message storage and display.

Terminal receives the notification from the server and interprets the classification and recommended actions. The input of this step is the notification message from Step 15. The terminal updates its local storage by moving messages classified into the exclusion-information category to a designated isolation folder and marking suspicious messages with a visual indicator. The terminal then refreshes the display to show warnings or status icons next to the affected messages. The output of this step is an updated message list on the terminal and a modified local storage state that reflects the server's classification.

### Step 17:

User reviews the terminal display and optionally provides corrective feedback.

User views the updated message list and any warnings or classification markers displayed by the terminal. The input of this step is the graphical presentation generated by the terminal in Step 16. The user may accept the classification or manually reclassify specific messages (for example, moving a suspected spoofed message back to a normal folder). If the user performs such corrective actions, the terminal generates feedback data and sends it back to the server. The output of this step, when corrective feedback is given, is additional information that the server can later incorporate into history-based updates of matching criteria and filtering policies.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

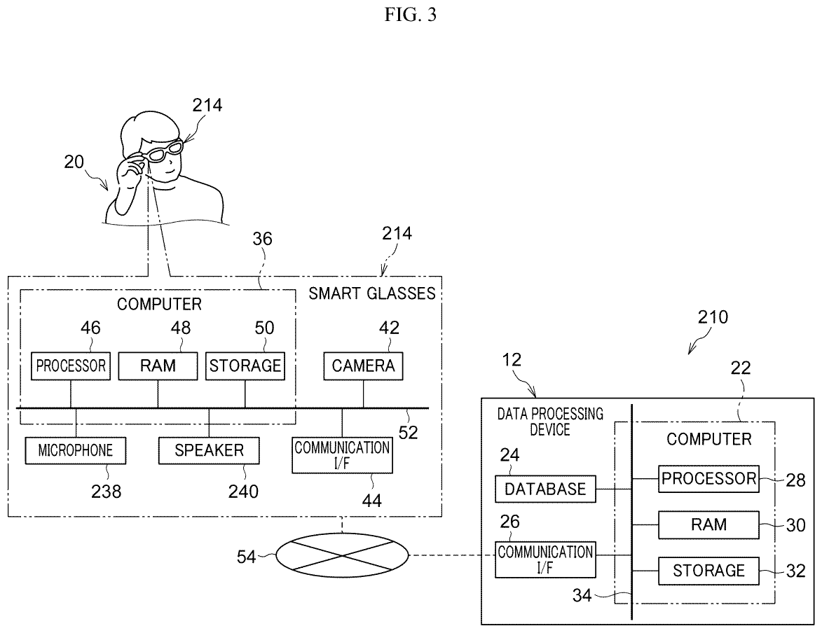

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

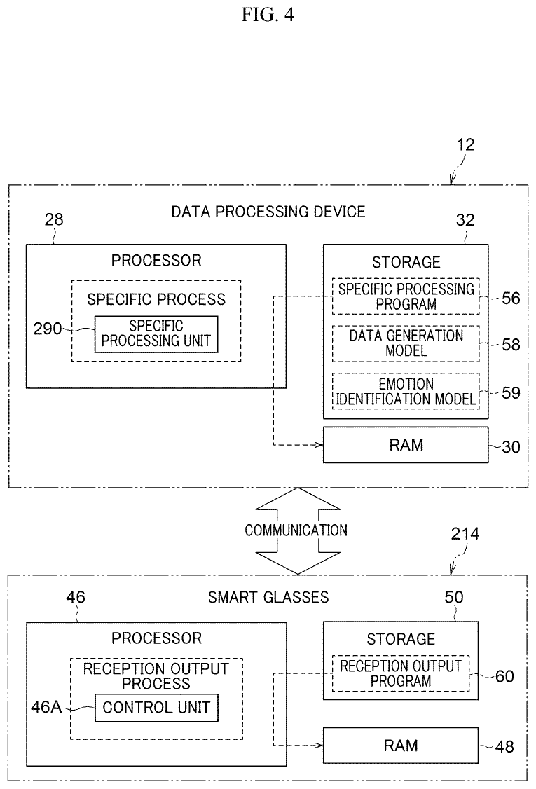

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

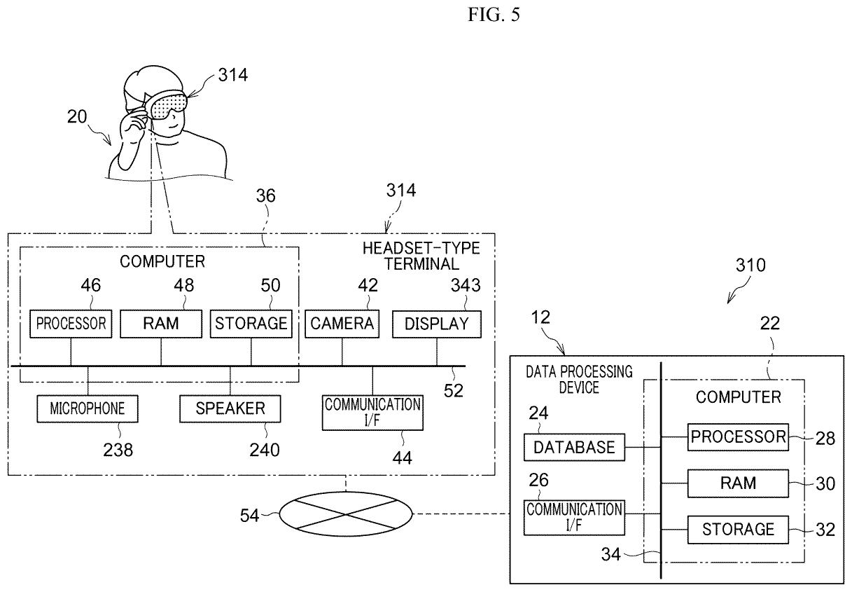

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

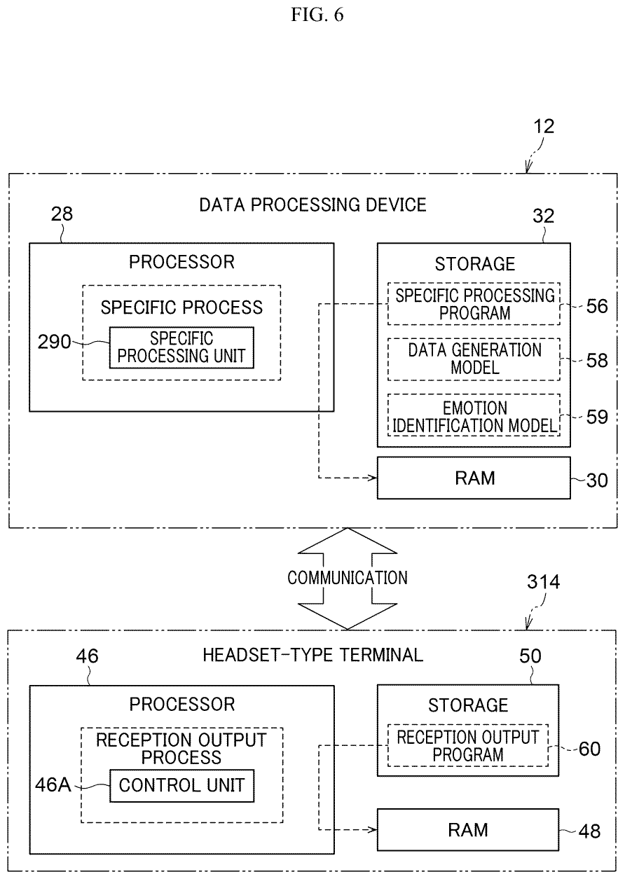

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

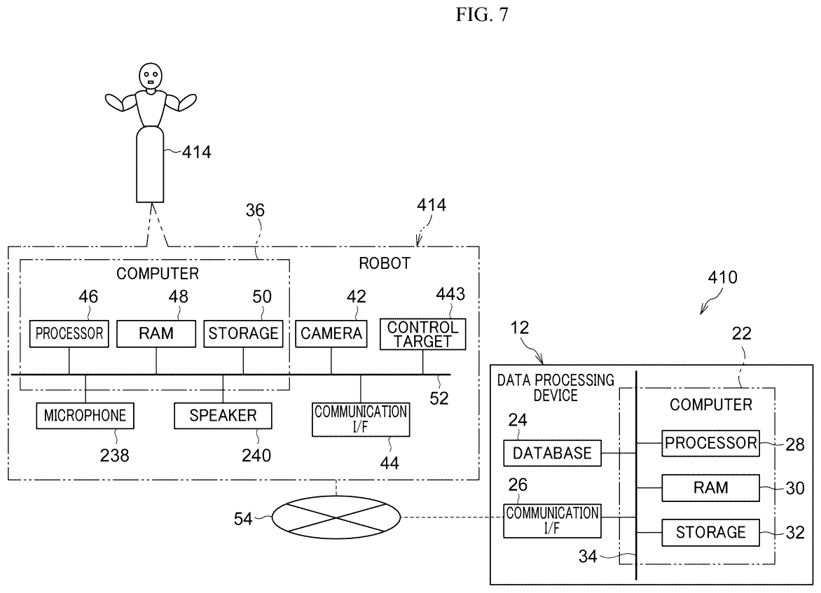

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

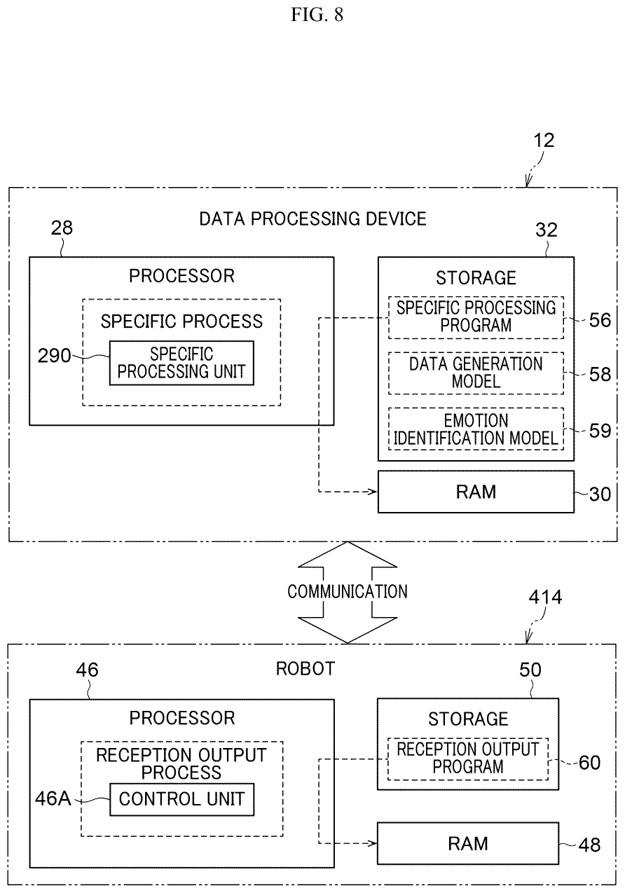

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

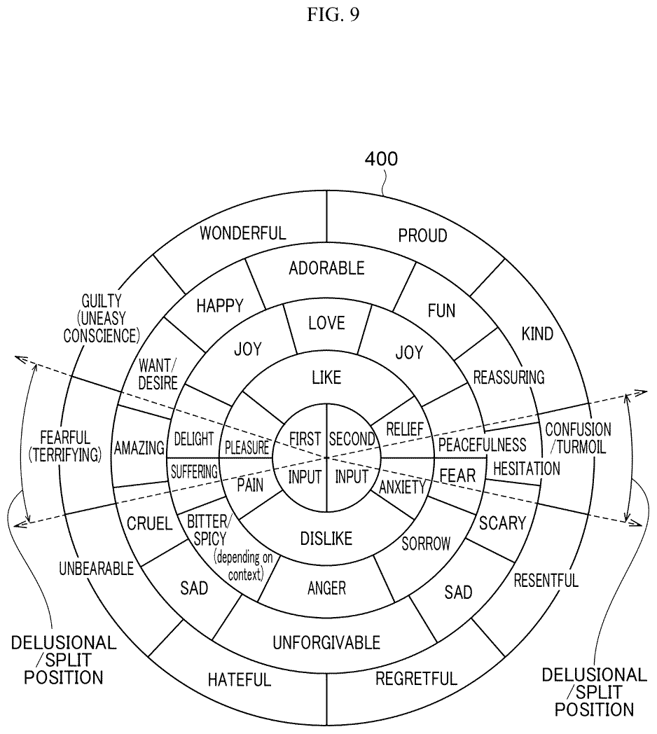

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

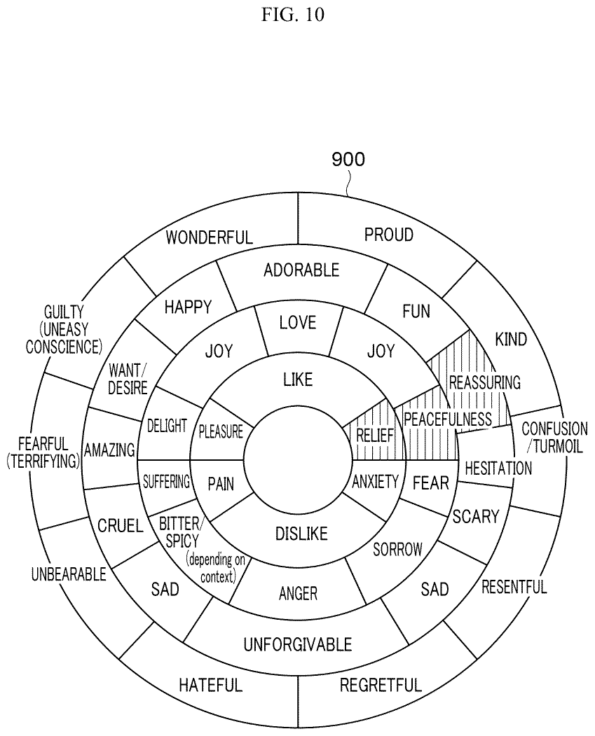

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
   receive, from a user terminal, identification information and content information as input data, and generate a prompt sentence that includes at least the identification information and the content information and that instructs a generative AI model to perform information retrieval, and
   input the prompt sentence into the generative AI model, obtain response information including legitimate identification information of a transmission source based on information sources on a communication network from the generative AI model, and extract the legitimate identification information of the transmission source from the response information, and
   normalize the legitimate identification information of the transmission source and the identification information received as the input data, compare the normalized identification information with each other, and determine whether impersonation is present or absent based on a predetermined matching criterion or similarity criterion, and
   generate notification information representing a result of the determination of whether the impersonation is present or absent and transmit the notification information to the user terminal, and
   when the result of the determination indicates that the impersonation is present, filter corresponding communication data stored in a communication apparatus or a storage apparatus and exclude the communication data from a reception area of the user terminal.

### (Supplementary 2)

### The System According to Supplementary 1,

wherein the processor is configured to
   configure the prompt sentence to include at least the identification information and the content information and to instruct the generative AI model, using natural language, to extract and return only the legitimate identification information of the transmission source, and cause the generative AI model to perform information retrieval and response generation based on natural language processing technology in accordance with the prompt sentence.

### (Supplementary 3)

The system according to supplementary 1,
wherein the processor is configured to
   record, in a storage apparatus as history information, the identification information, the legitimate identification information of the transmission source, the result of the
   determination of whether the impersonation is present or absent, and the response information from the generative AI model, and adjust the predetermined matching criterion or the similarity criterion based on the history information.

### Application Example 1

### (Supplementary 1)

A system comprising a processor,
wherein the processor is configured to receive, via a communication apparatus connected to an information processing apparatus, input information including a sender identifier and communication content information from a user information processing apparatus,
wherein the processor is configured to generate a prompt sentence, based on the sender identifier and the communication content information included in the input information, the prompt sentence defining a content of an information retrieval process to be executed by a generative information processing model,
wherein the processor is configured to input the generated prompt sentence into the generative information processing model, to cause the generative information processing model to acquire, from a public information source, legitimate identification information corresponding to a sender and explanation information related to the legitimate identification information, and to obtain the legitimate identification information and the explanation information,
wherein the processor is configured to compare a legitimate identifier extracted from the acquired legitimate identification information with the sender identifier included in the input information, based on a determination criterion including a character string comparison process and a similarity calculation process, and to generate an impersonation determination result and reliability information related to the impersonation determination result, wherein the processor is configured to generate determination information including the impersonation determination result and the explanation information, and to transmit the determination information as notification information to the user information processing apparatus,
wherein the processor is configured to generate classification instruction information for causing the user information processing apparatus to classify message information corresponding to the communication content information into a suspicious message storage area among storage areas of the user information processing apparatus, in accordance with the impersonation determination result, and to transmit the classification instruction information to the user information processing apparatus, and
wherein the processor is configured to record the impersonation determination result and the reliability information in a storage apparatus in association with an identifier and time information.
   (supplementary 2)

The system according to supplementary 1,
wherein the processor is configured to control the generative information processing model to execute the information retrieval process based on the prompt sentence by using natural language processing technology, and to output the legitimate identification information corresponding to the sender and the explanation information related to the legitimate identification information in a structured data format, and wherein the processor is configured to parse the structured data format to extract the legitimate identifier and the explanation information.

### (Supplementary 3)

The system according to supplementary 1,
wherein the processor is configured to, in response to a display request from the user information processing apparatus, cause the determination information including the impersonation determination result and the explanation information to be presented, to acquire correction reception information from the user information processing apparatus, the correction reception information indicating a correction operation by a user with respect to the impersonation determination result, and to update the impersonation determination result recorded in the storage apparatus based on the correction reception information.

### Example 2

### (Supplementary 1)

A system comprising a processor,
wherein the processor is configured to
   receive, from an external device via a communication path, source identification information and information related to the source identification information as input data, and generate a prompt sentence, based on the received source identification information and the related information, for instructing a generative artificial intelligence model to perform information retrieval,
   input the generated prompt sentence into the generative artificial intelligence model, control an information acquisition process for searching public information sources based on a response obtained from the generative artificial intelligence model, and acquire candidate information including legitimate source identification information by using information browsing software operating on an information providing apparatus connected via a network, extract the legitimate source identification information from the candidate information, compare the extracted legitimate source identification information with the received source identification information based on a character string comparison algorithm or a similarity calculation algorithm, and determine whether spoofing is present according to a comparison result,
   generate notification information indicating a determination result regarding the presence or absence of spoofing and the legitimate source identification information, and transmit the notification information to the external device, and
   classify information associated with spoofing, when it is determined that spoofing is present, based on a predefined classification criterion, and control a storage location or a display format of the information according to a classification result.

### (Supplementary 2)

The system according to supplementary 1,
wherein the processor is configured to control the information browsing software, which is a screen display control program operating on a general-purpose information processing apparatus, to acquire the candidate information including the legitimate source identification information by generating a search query based on the response obtained from the generative artificial intelligence model, inputting the search query into the screen display control program, and causing the screen display control program to search information resources on a public information network.
   (supplementary 3)

The system according to supplementary 1,
wherein the processor is configured to, when the determination result regarding the presence or absence of spoofing indicates that spoofing is present, automatically assign the information associated with spoofing to any one of a plurality of categories including at least one of unauthorized communication information, advertising information, and suspicious transaction information, and perform memory control of the external device or an information processing apparatus so as to move the information to a storage area or a display area corresponding to the assigned category.

### Application Example 2

### (Supplementary 1)

A system comprising a processor,
wherein the processor is configured to
   receive information as input, and generate a prompt sentence for instructing a generative AI model to perform information retrieval, the prompt sentence being generated on the basis of identification information and content information included in the information; and input the generated prompt sentence to the generative AI model, obtain normal source identification information from information sources including network-based information resources, and analyze a response result from the generative AI model and the information obtained from the information resources to extract a candidate of the normal source identification information; and
   compare the extracted candidate of the normal source identification information with the identification information received as the input, based on at least one of string matching degree, domain structure, similarity index, and a preset matching criterion, and determine whether or not the information is spoofing based on a comparison result, and generate a spoofing determination result; and
   analyze emotion-related information acquired in association with the information to specify an emotional state of a user, and dynamically adjust at least one of the matching criterion and a determination threshold according to the emotional state, thereby changing filtering strength of the spoofing determination; and
   automatically classify the information into at least one of a safe-information category, a suspicious-information category, and an exclusion-information category, based on the spoofing determination result and the filtering strength, notify an external apparatus of a classification result, and automatically move information classified into the exclusion-information category to an isolation area; and
   record, in a storage device, history information including at least the spoofing determination result, the candidate of the normal source identification information, the emotional state, and the filtering strength, and store and manage the history information in a form usable for subsequent determination processing and criterion updating processing.

### (Supplementary 2)

The System According to Supplementary 1,
wherein the processor is configured to cause the generative AI model to perform the information retrieval and response generation by using natural language processing technology based on the prompt sentence, to cause the generative AI model to estimate the candidate of the normal source identification information, and to extract the candidate of the normal source identification information based on analysis of response content obtained by the natural language processing technology.

### (Supplementary 3)

The system according to supplementary 1,
wherein the processor is configured to acquire, as the emotion-related information, at least one of text input information, voice information, and image information from the user, estimate the emotional state of the user by emotion recognition processing, and change at least one of the matching criterion and the filtering strength according to the estimated emotional state.

What is claimed is:

1. A system comprising:
a communication interface connected to a packet-switched network;
a storage medium; and
circuitry configured to:
receive, via the communication interface and the packet-switched network, input data comprising source identification data and associated content data from a terminal device;
construct a prompt sequence based on the source identification data and the associated content data, the prompt sequence instructing a generative neural network model to perform an information retrieval operation;
input the prompt sequence to the generative neural network model and obtain, from the generative neural network model, response data comprising reference identification data;
normalize the reference identification data and the source identification data to a canonical format;
compare the normalized reference identification data with the normalized source identification data based on a matching criterion to generate a verification result; and
transmit, via the communication interface and the packet-switched network, notification data representing the verification result to the terminal device.

2. The system according to claim 1, wherein the circuitry is further configured to extract a domain component and a local component from each of the normalized reference identification data and the normalized source identification data, and to perform the comparison separately on the domain component and the local component.

3. The system according to claim 2, wherein comparing the domain component comprises computing an edit distance value between the domain component of the normalized reference identification data and the domain component of the normalized source identification data, and wherein the matching criterion comprises a similarity threshold applied to the edit distance value.

4. The system according to claim 3, wherein the circuitry is further configured to detect a character substitution pattern in which an alphabetic character in the domain component of the source identification data is replaced with a visually similar numeral or symbol character, and to incorporate the detected character substitution pattern as a factor in the verification result.

5. The system according to claim 4, wherein the circuitry is further configured to, when the verification result indicates a mismatch, transmit a filter control command to a communication apparatus to relocate communication data associated with the source identification data from a primary storage area to an isolation storage area of the terminal device.

6. The system according to claim 1, wherein the circuitry is further configured to parse the response data from the generative neural network model using pattern matching to extract one or more candidate reference identifiers, and to store each candidate reference identifier in a structured data collection with an associated confidence attribute.

7. The system according to claim 6, wherein the circuitry is further configured to execute an information retrieval process using information browsing software to access one or more network-based information resources, to extract additional candidate reference identifiers from the accessed information resources, and to merge the additional candidate reference identifiers with the one or more candidate reference identifiers into a unified candidate set.

8. The system according to claim 7, wherein the information retrieval process comprises generating a search query based on the response data from the generative neural network model, inputting the search query into the information browsing software, and parsing retrieved content to extract the additional candidate reference identifiers.

9. The system according to claim 1, wherein the generative neural network model comprises a transformer architecture having a plurality of self-attention layers and feed-forward sub-layers, and wherein the circuitry is further configured to convert the prompt sequence into a token sequence using a tokenizer and to control decoding parameters comprising at least one of a temperature parameter and a maximum output token count.

10. The system according to claim 9, wherein the circuitry is further configured to configure the decoding parameters with a low temperature value to produce stable and reproducible response data for the information retrieval operation.

11. The system according to claim 10, wherein the prompt sequence further includes instruction data specifying that the generative neural network model is to return only the reference identification data in a structured output format, and wherein the circuitry parses the structured output format to extract the reference identification data.

12. The system according to claim 1, wherein the circuitry is further configured to record, in the storage medium, history data comprising the source identification data, the reference identification data, the verification result, and time information, and to adjust the matching criterion based on an analysis of accumulated history data.

13. The system according to claim 12, wherein adjusting the matching criterion comprises computing empirical error rates from the accumulated history data and modifying the similarity threshold to reduce at least one of a false positive rate and a false negative rate.

14. The system according to claim 1, wherein the circuitry is further configured to classify the input data into one of a plurality of categories comprising a verified category, a suspicious category, and an exclusion category based on the verification result, and to control a storage location or a display format of the input data on the terminal device according to the classified category.

15. The system according to claim 14, wherein the circuitry is further configured to, when the input data is classified into the exclusion category, automatically relocate communication data corresponding to the input data to an isolation storage area separate from a primary reception area of the terminal device.

16. The system according to claim 1, wherein the notification data further comprises explanation data generated based on the response data from the generative neural network model, the explanation data indicating a basis for the verification result.

17. The system according to claim 16, wherein the notification data further comprises reliability data indicating a confidence level associated with the verification result, the reliability data being computed based on a completeness of the reference identification data and a consistency of the response data.

18. A system comprising:
a communication interface connected to a packet-switched network;
a storage medium storing history data; and
circuitry configured to:
receive, via the communication interface and the packet-switched network, input data comprising source identification data and associated content data from a terminal device;
construct a prompt sequence based on the source identification data and the associated content data;
input the prompt sequence to a generative neural network model to obtain response data comprising reference identification data;
execute an information retrieval process using information browsing software to obtain additional reference data from network-based information resources;
merge the reference identification data and the additional reference data into a unified candidate set;
normalize and compare the source identification data with each entry in the unified candidate set based on a matching criterion to generate a verification result;
classify the input data into one of a verified category, a suspicious category, and an exclusion category based on the verification result;
transmit, via the communication interface and the packet-switched network, notification data comprising the verification result and a classification to the terminal device; and
record, in the storage medium, the verification result, the unified candidate set, and time information as updated history data.

19. The system according to claim 18, wherein the circuitry is further configured to adjust the matching criterion based on an analysis of the history data stored in the storage medium, and to, when the input data is classified into the exclusion category, transmit a filter control command to relocate corresponding communication data to an isolation storage area of the terminal device.

20. A method performed by circuitry, the method comprising:
receiving, via a communication interface connected to a packet-switched network, input data comprising source identification data and associated content data from a terminal device;
constructing a prompt sequence based on the source identification data and the associated content data, the prompt sequence instructing a generative neural network model to perform an information retrieval operation;
inputting the prompt sequence to the generative neural network model and obtaining, from the generative neural network model, response data comprising reference identification data;
normalizing the reference identification data and the source identification data to a canonical format;
comparing the normalized reference identification data with the normalized source identification data based on a matching criterion to generate a verification result; and
transmitting, via the communication interface and the packet-switched network, notification data representing the verification result to the terminal device.
